(19) United States
(12) Patent Application Publication
(10) Pub. No.: US 2006/0192922 A1
(43) Pub. Date: Aug. 31, 2006

(54) Projector

(75) Inventor: Koichi Akiyama, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/354,162

(22) Filed: Feb. 15, 2006

(30) Foreign Application Priority Data
Feb. 28, 2005 (JP) 2005-052597
Nov. 7, 2005 (JP) 2005-321819

(51) Int. Cl. G03B 21/00

(52) U.S. Cl. 353/33

(57) ABSTRACT

A projector includes an electrooptic modulator that modulates an illumination light flux in accordance with image information; a projection optical system that projects the illumination light flux modulated at the electrooptic modulator; an illuminating system that so as to illuminate an entire image forming area in one direction on an image forming area of the electrooptic modulator and to partially illuminate the image forming area in the other direction, emits an illumination light flux having a sectional form compressed in the other direction of directions; and a rotating prism that is rotated at a constant speed so that an illumination light flux from the illuminating system scan along the other direction over the image forming area of the electrooptic modulator, wherein the projector further includes: a light transmittance control module that changes a light transmittance of the illumination light flux depending on a position of the illumination light flux over the image forming area so as to reduce a difference in illuminance caused by changes in a scanning rate of the illumination light flux over the image forming area of the electrooptic modulator

### BACKGROUND

The present invention relates to a projector.

A projector is known in which illumination light flux scans over an image forming area of a liquid crystal device to improve moving picture display equality (for example, see JP-A-2004-325577).

FIGS. 17A to 17C are diagrams illustrative of a related art projector 900 like this. FIG. 17A is a diagram illustrating an optical system of the related art projector 900. FIG. 17B is diagrams illustrative of the operation of a rotating prism 960. FIG. 17C is diagrams illustrating a manner that an illumination light flux scans over an image forming area of a liquid crystal device 970 by rotating the rotating prism 960. FIG. 18 is a diagram illustrating the rotation speed of the rotating prism 960 in the related art projector 900.

As shown in FIGS. 17A to 17C, in the related art projector 900, the rotating prism 960 is rotated so that an illumination light flux L scans over the image forming area of the liquid crystal device 970. Therefore, according to the related art projector 900, when attention is focused on a given point in the image forming area of the liquid crystal device 970, light is blocked intermittently. Thus, the moving picture display quality is improved to provide excellent moving picture display quality.

Furthermore, as shown in FIG. 18, in the related art projector 900, the rotation speed of the rotating prism 960 is varied so that the illumination light flux L scans at a uniform velocity over the image forming area of the liquid crystal device 970. Thus, according to the related art projector 900, the difference between the illuminance is reduced in the image forming area of the liquid crystal device 970, and then uniform display can be done throughout the projection plane. More specifically, uniform in-plane display quality is provided.

However, in the related art projector 900, it is required to accurately change the rotation speed of the rotating prism in a very short period. Thus, a problem arises that an expensive motor has to be used for a motor to drive the rotating prism, leading to increased fabrication costs. Moreover, in the related art projector 900, it is necessary to change the rotation speed of the rotating prism in a very short period. Therefore, a problem arises that it is required to frequently increase and reduce the rotation speed of the motor to drive the rotating prism, leading to increased power consumption.

### SUMMARY

An advantage of some exemplary embodiments of the invention is to provide a projector which has excellent moving picture display quality and uniform in-plane quality with no increase neither in fabrication costs nor in power consumption.

A projector according to an exemplary embodiment of the invention can include an electrooptic modulator that modulates an illumination light flux in accordance with image information, a projection optical system that projects the illumination light flux modulated by the electrooptic modulator; an illuminating system that so as to illuminate an entire image forming area in one direction on an image forming area of the electrooptic modulator and to partially illuminate the image forming area in the other direction, emits an illumination light flux having a sectional form compressed in the other direction of directions, and a rotating prism that is rotated at a constant speed so that an illumination light flux from the illuminating system scans along the other direction over the image forming area of the electrooptic modulator, wherein the projector can further include a light transmittance control module that changes a light transmittance of the illumination light flux depending on a position of the illumination light flux over the image forming area so as to reduce a difference in illuminance caused by changes in a scanning rate of the illumination light flux over the image forming area of the electrooptic modulator.

Therefore, according to the projector of an exemplary embodiment of the invention, the rotating prism is rotated so that the illumination light flux scans over the image forming area of the electrooptic modulator. Consequently, when attention is focused on a given point in the image forming area of the electrooptic modulator, light is intermittently blocked. Thus the moving picture display quality if improved, and the excellent moving picture display quality is provided.

Furthermore, according to the projector of an exemplary embodiment of the invention, the light transmittance of the illumination light flux can be changed so as to reduce the difference between the illuminance. Therefore, a reduction is achieved in the difference between the illuminance, the difference occurring when the rotating prism is rotated at a constant rotation speed (since the scanning rate of the illumination light flux, at both ends in the other direction in the image forming area of the electrooptic modulator becomes faster than the scanning rate of the illumination light flux at the center part in the other direction, the illuminance at both ends in the other direction in the image forming area of the electrooptic modulator becomes lower than the illuminance at the center part in the other direction). Thus, more uniform display can be done throughout the projection plane. More specifically, uniform in-plane display properties are provided.

In this case, control is done such that when the illumination light flux passes through at the center part in the other direction in the image forming area of the electrooptic modulator, the light transmittance of the illumination light flux becomes low, whereas when the illumination light flux passes through both ends in the other direction in the image forming area of the electrooptic modulator, the light transmittance of the illumination light flux becomes high.

Moreover, according to the projector of an exemplary embodiment of the invention, the rotation speed of the rotating prism does not need to be varied in a very short period. Therefore, an expensive motor does not need to be used as a motor to drive the rotating prism as well as the rotation speed of the motor does not need to be frequently increased and reduced to drive the rotating prism. Thus, it can be eliminated to increase in fabrication costs and power consumption.

Accordingly, according to the projector of an exemplary embodiment of the invention, a projector is formed which has excellent moving picture display quality and uniform in-plane display properties with no increase in fabrication costs nor in power consumption to achieve an advantage of the invention.

It is preferable that the light transmittance control module has a light transmittance control member and a light transmittance control circuit that controls light transmittances of the light transmittance control member.

With this configuration, reliable control of the light transmittance of the illumination light flux can be implemented easily so as to reduce the difference between the illuminance as described above.

It is preferable that the electrooptic modulator is a liquid crystal device, further including a polarization conversion device that rearranges the illumination light flux into almost one type of linear polarized light, and the light transmittance control member has a polarization direction control member that controls a polarization direction of the almost one type of linear polarized light depending on control from the light transmittance control circuit; and a polarizing plate that transmits only one polarization component of polarization components of an illumination light flux emitted from the polarization direction control member.

In this case, it is preferable that the polarizing plate is disposed on a light emitting side of the polarization direction control member. Alternatively, it is preferable that in the polarizing plate, an incoming polarizing plate is used which is disposed on an incident side of the electrooptic modulator to rearrange a polarization direction of an illuminator light flux to enter the electrooptic modulator.

With this configuration, control by the light transmittance control circuit can change the polarization direction of the illumination light flux passing through the polarization direction control member, and can adjust the light quantity of the illumination light flux, absorbed at the polarizing plate or the incoming polarizing plate disposed on the incident side of the electrooptic modulator. Accordingly, the light transmittance of the illumination light flux can be accurately controlled at low power consumption.

It is preferable that it further includes a rotating state sensor that senses a rotating state of the rotating prism, wherein the light transmittance control circuit controls a light transmittance of the light transmittance control member based on the output signal of the rotating state sensor.

With this configuration, reliable control corresponding to the rotating state of the rotating prism can be done. Accordingly, the difference between the illuminance caused by changes in the scanning rate of the illumination light flux over the image forming area of the electrooptic modulator can be reduced effectively.

It is preferable that it further includes an image processing circuit that processes image information, wherein the rotating prism is configured to rotate at a constant speed based on a synchronization signal from the image processing circuit, and the light transmittance control circuit controls a light transmittance of the light transmittance control member based on a synchronization signal from the image processing circuit.

The rotating prism is rotated based on the synchronization signal from the image processing circuit. Therefore, also with the configuration as described above, reliable control corresponding to the rotating state of the rotating prism can be done. Accordingly, the difference between the illuminance caused by changes in the scanning rate of the illumination light flux over the image forming area of the electrooptic modulator can be reduced effectively.

It is preferable that the illuminating system is an illuminating system having a light source device that includes an arc tube and a reflector and that emits an illumination light flux to an illuminated area side, a first lens array that has a plurality of fir small lenses to split an illumination, light flux emitted from the light source device into a plurality of partial light fluxes; a second lens array that has a plurality of second small lenses corresponding to a plurality of the first small lenses of the first lens array; and an superposing lens that superposes with the light transmittance control member each of the partial light fluxes emitted from a plurality of the second small lenses of the second lens array, wherein the first small lens has a plane from compressed in the other direction respectively.

With this configuration, the illuminating system formed of the lens integrator optical system described above is used to emit the illumination light flux having the sectional form compressed in the other direction with the uniform in-plane illuminance distribution, allowing improved light efficiency of use. Consequently, the projector can be configured which has excellent moving picture display quality and uniform in-plane display properties with no increase neither in fabrication costs nor in power consumption.

It is preferable that the illuminating system is an illuminating system having a light source device that includes an arc tube and an ellipsoidal reflector and that emits a converging illumination light flux to an illuminated area side; and an integrator rod that converts an illumination light flux from the light source device into an illumination light flux having more uniform intensity distribution, wherein a light emitting plane of the integrator rod has a plane form compressed in the other direction.

With this configuration, the illuminating system formed of the rod integrator optical system described above is used to emit the illumination light flux having the sectional form compressed in the other direction with the uniform in-plane illuminance distribution allowing improved light efficiency of use. Consequently, the projector can be configured which has excellent moving picture display quality and uniform in-plane display properties with no increase neither in fabrication costs nor in power consumption.

It is preferable that the rotating prism is disposed at a position almost optically conjugated with the image forming area of the electrooptic modulator.

Also with this configuration, the projector can be configured which has excellent moving picture display quality and uniform in-plane display properties with no increase neither in fabrication costs nor in power consumption.

It is preferable that the polarization direction control member is disposed at a position almost optically conjugated with the image forming area of the electrooptic modulator.

In the projector according to an exemplary embodiment of the invention, the polarization direction control member may be disposed at any places as long as the place is in the optical path through which the illumination light flux passes. However, the cross-sectional area of the illumination light flux is small at the position almost optically conjugated with the image forming area of the electrooptic modulator. Accordingly, as described above, the polarization direction control member is placed at this place to reduce the size of the polarization direction control member, allowing a reduction in fabrication costs.

It is preferable that the polarization direction control member further has a function as a light shielding member that shapes a sectional form of an illumination light flux.

With this configuration, because of the function as the light shielding member in the polarization direction control member, the sectional form of the illumination light flux emitted from the polarization direction control member can be correctly shaped into the sectional form of the illumination light flux irradiated onto the image forming area of the electrooptic modulator.

It is preferable that the projector further includes a plurality of electrooptic modulators that modulates a plurality of color lights in accordance with image information corresponding to the individual color lights as the electrooptic modulator, a color separation light guide optical system that is disposed between the rotating prism and a plurality of the electrooptic modulators and that separates the illumination light flux from the rotating prism into a plurality of color lights to guide them to a plurality of the electrooptic modulators, and a cross dichroic prism that combines the individual color lights modulated at a plurality of the electrooptic modulator.

With this configuration, a projector which as excellent moving picture display quality and uniform in-plane display properties with no increase in fabrication costs nor in power consumption can be formed in a full-color projector which has excellent image quality (for example, a three-panel type full-color projector).

### BRIEF DESCRIPTION OF THE DRAWINGS

The exemplary embodiments will be described with reference to the accompanying drawings, wherein like numbers reference like elements, and wherein:

FIGS. 1A to 1E are diagrams illustrative of the projector 1000 according to a first exemplary embodiment;

FIGS. 2A to 2C are diagrams illustrating the relationship between the rotation of a rotating prism 770 and the illuminating state on liquid crystal devices 400R, 400G and 400B;

FIGS. 3A to 3E are diagrams illustrating the relationship between the illuminating state of the illumination light flux L in the image forming areas S of the liquid crystal devices 400R, 400G and 400B and the slope angle θ of the rotating prism 770;

FIGS. 4A to 4C are diagrams illustrative of the projector according to comparative exemplary;

FIGS. 5A to 5E are diagrams illustrative of the light transmittance control member 700;

FIGS. 6A to 6D are diagrams illustrative of the light transmittance control member 700;

FIGS. 7A to 7C are diagrams illustrative of the effect of the light transmittance control member 700 and the light transmittance control circuit 740;

FIG. 8 is a block diagram illustrative of the light transmittance control member 700 and the light transmittance control circuit 740 of the projector 1000 according to the first exemplary embodiment;

FIG. 9 is a diagram illustrative of a projector 1002 according to a second exemplary embodiment;

FIGS. 10A to 10D are diagrams illustrative of a projector 1004 according to a third exemplary embodiment;

FIGS. 11A and 11B are diagrams illustrating an optical system of a projector 1006 of a fourth exemplary embodiment;

FIGS. 12A and 12B are diagrams illustrating an optical system of a projector 1008 according to a fifth exemplary embodiment;

FIGS. 13A and 13B are diagrams illustrating an optical system of a projector 1010 according to a sixth exemplary embodiment;

FIGS. 14A to 14C are diagrams illustrating the relationship between the rotation of a rotating prism 770 and the illuminating states on liquid crystal devices 400R, 400G and 400B;

FIGS. 15A to 15C are diagrams illustrative of a projector 1012 according to a seventh exemplary embodiment;

FIGS. 16A to 16D are diagrams illustrative of the projector 1012 according to the seventh exemplary embodiment;

FIGS. 17A to 17C are diagrams illustrative of a related art projector 900; and

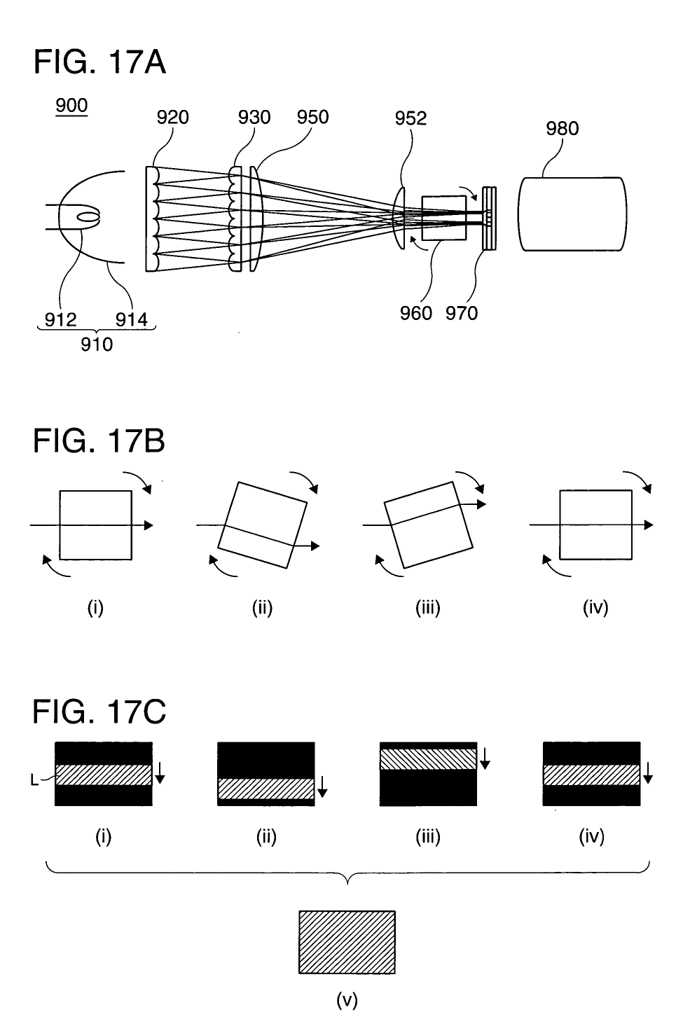

FIG. 18 is a diagram illustrating the rotation speed of a rotating prism 960 of the related art projector 900.

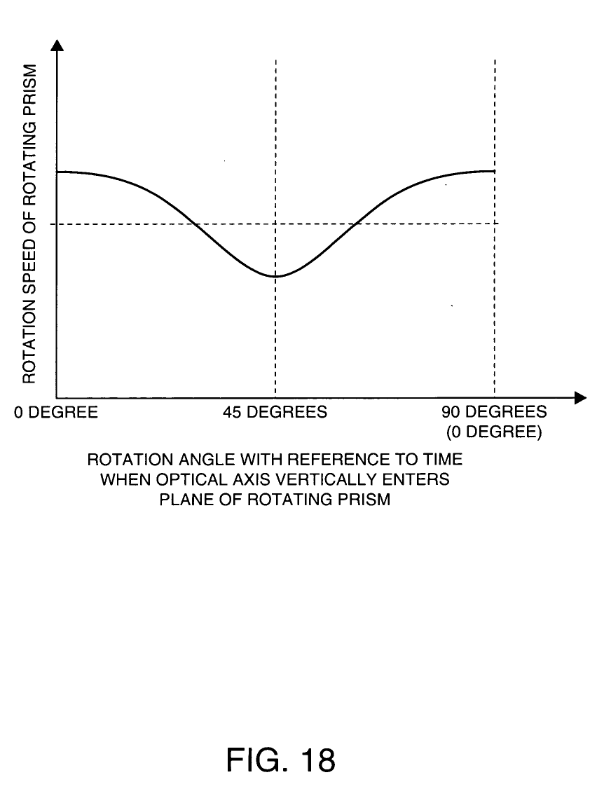

### DESCRIPTION OF EXEMPLARY EMBODIMENTS

Hereinafter, the projector according to an exemplary embodiment of the invention will be described with reference to the drawings.

### First Exemplary Embodiment

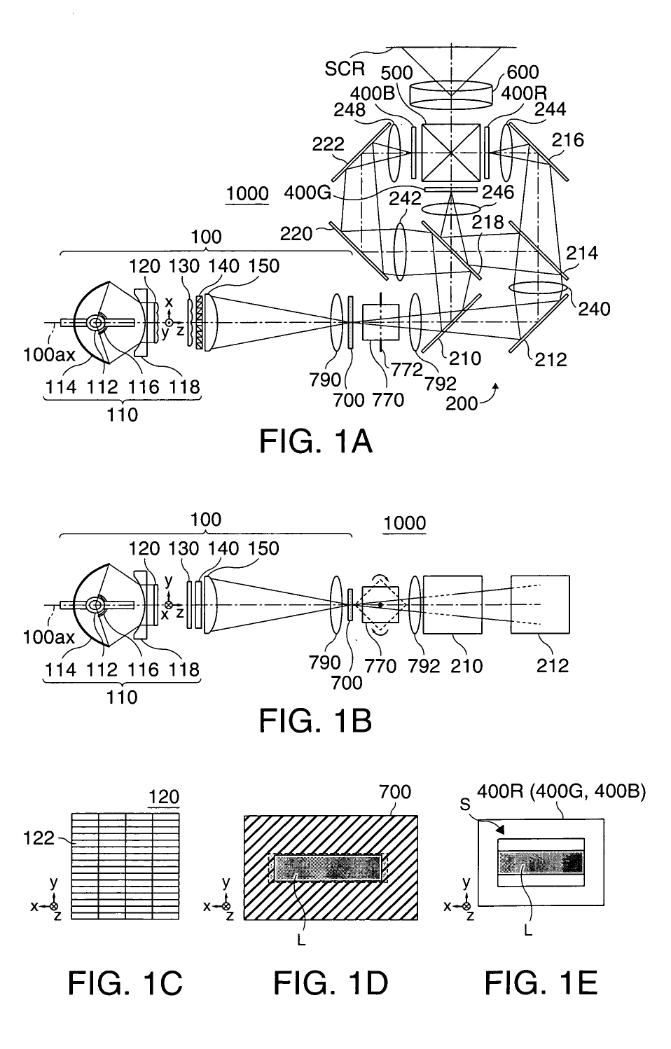

First, a project 1000 according to a first exemplary embodiment will be described with reference to FIGS. 1A to 1E. FIGS. 1A to 1E are diagrams illustrative of a projector 1000 according to the first exemplary embodiment.

FIG. 1A is a diagram of an optical system of the projector 1000 seen from the top. FIG. 1B is a diagram of the optical system of the projector 1000 seen from the side. FIG. 1C is a front view of a first lens array 120. FIG. 1D is a diagram illustrating an illuminating state on a light transmittance control member 700. FIG. 1E is a diagram illustrating an illuminating state on a liquid crystal device 400R.

In addition, in the description below, three directions orthogonal to one another are the Z-axis direction (the direction of an illumination optical axis 100ax in FIG. 1A), the X-axis direction (a direction in parallel with the paper surface in FIG. 1A and orthogonal to the Z-axis), and the Y-axis direction (a direction vertical to in the paper surface in FIG. 1A and orthogonal to the Z-axis).

As shown in FIGS. 1A and 1B, the projector 1000 according to the first exemplary embodiment is a projector having an illuminating system 100, a color separation light guide optical system 200 which separates an illumination light flux from the illuminating system 100 into three color light, red light, green light and blue light, and guides them to the illuminated are, liquid crystal devices 400R, 400G and 400B as electrooptic modulators which modulate each of three color lights separated at the color separation light guide optical system 200 in accordance with image information, a cross dichroic prism 500 which combines color lights modulated at the three liquid crystal devices 400R, 400G and 400B, and a projection optical system 600 which projects the light combined at the cross dichroic prism 500 onto a projection plane such as a screen SCR.

The illuminating system 100 has a light source device 110 which emits an illumination light flux almost in parallel with the illuminated area side, a first lens array 120 which has a plurality of first small lenses 122 that splits the illumination light flux emitted from the light source device 110 into a plurality of partial light fluxes, a second lens array 130 which has a plurality of second small lenses 132 (not shown) that correspond to a plurality of the first small lenses 122 of the first lens array 120, a polarization conversion device 140 which rearranges the illumination light flux emitted from the light source device 110 with the nonuniform polarization directions into almost one type of linear polarized light, and an superposing lens 150 which superposes each of the partial light fluxes emitted from the polarization conversion device 140 in the illuminated area.

The light source device 110 has an ellipsoidal reflector 114, an arc tube 112 which has the center of light emission near a first focal point of the ellipsoidal reflector 114, and a parallel lens 118 which converts the converging light reflected by the ellipsoidal reflector 114 to substantially parallel light. On the arc tube 112, an auxiliary mirror 116 is disposed as a reflecting module in which the light emitted from the arc tube 112 to the illuminated area side is reflected toward the arc tube 112.

The arc tube 112 has a vessel, and a pair of sealing parts extending to both sides of the vessel.

The ellipsoidal reflector 114 has a tube-liked neck part which is inserted and fixed to one sealing part of the arc tube 112, and a reflection concave which reflects the light radiated from the arc tube 112 toward the position of a second focal point.

The auxiliary mirror 116 is a reflecting member which covers nearly a half of the vessel of the arc tube 112, and which is placed as it faces the reflection concave of the ellipsoidal reflector 114, and is inserted and fixed to the other sealing part of the arc tube 112.

With the use of the auxiliary mirror 116 like this, the light radiated from the arc tube 112 toward the opposite side of the ellipsoidal reflector 114 (the illuminated area side) is reflected toward the arc tube 112 at the auxiliary mirror 116. The light reflected at the auxiliary mirror 116 is radiated from the arc tube 112 to the ellipsoidal reflector 114, further reflected at the reflection concave of the ellipsoidal reflector 114 and converged at the position of the second focal point. As similar to the light directly radiated from the arc tube 112 to the ellipsoidal reflector 114, it can be converged at the position of the second focal point of the ellipsoidal reflector 114.

The parallel lens 118 is formed of a concave lens, which is placed on the illuminated area side of the ellipsoidal reflector 114. It is configured to form the light from the ellipsoidal reflector 114 almost parallel.

The first lens array 120 has a function as a luminous flux split optical device which splits the light from the parallel lens 118 into a plurality of partial light fluxes, which is configured to have a plurality of first small lenses 122 arranged in a matrix in a plane orthogonal to the illumination optical axis 100ax. As shown in FIG. 1C, the first small lenses 122 are arranged in four rows in the transverse direction and in 16 columns in the longitudinal direction, and have of “a rectangular plane form, the length in the Y-axis direction to the width in the X-axis direction □ 1:4”.

More specifically, the first small lenses 122 in the first lens array 120 have “a rectangular plane form, the length in the Y-axis direction to the width in the X-axis direction □ 1:4”, which is vertically compressed such that the illumination light flux emitted from the illuminating system 100 is formed into an illumination light flux having a sectional form that illuminates an entire image forming area S in the transverse direction along the X-axis direction and illuminates about 50 of the image forming area S in the longitudinal direction along the Y-axis direction in the transverse direction of the image along forming area S in the liquid crystal devices 400R, 400G and 400B (see FIG. 1E).

The second lens array 130 is an optical device which gathers a plurality of partial light fluxes split at the first lens array 120, and which is configured to have a plurality of second small lenses 132 arranged in a matrix, in a plane orthogonal to the illumination optical axis 100ax as similar to the first lens array 120. The second small lenses 132 have a plane form that is compressed in the longitudinal direction (the Y-axis direction) as analog to the plane from of the first small lenses 122.

The polarization conversion device 140 is a polarization conversion device which emits each of the partial light fluxes split at the first lens array 120 as almost one type of linear polarized light in which the polarization direction thereof is the uniform polarization direction.

The polarization conversion device 140 has a polarization separation layer which transmits one of linear polarized light components contained in the illumination light flux from the light source device 110 and reflects the other linear polarized light component in the direction vertical to the illumination optical axis 100ax, a reflective layer which reflects the other linear polarized light component reflected at the polarization separation layer in the direction in parallel with the illumination optical axis 100ax, and a retardation film which does polarization conversion so as to rearrange a linear polarized light component into the one linear polarized light component transmitted through the polarization separation layer or the other linear polarized light component reflected at the reflective layer.

The superposing lens 150 is an optical device which gathers and superposes a plurality of partial light fluxes having passed through the first lens array 120, the second lens array 130, and the polarization conversion device 140 with the light transmittance control area of the light transmittance control member 700 (see FIG. 1D). An image on the light transmittance control area of the light transmittance control member 700 is again formed on the image forming areas S of the liquid crystal devices 400R, 400G and 400B (see FIG. 1E) by an optical device describe later.

With the illuminating system 100 thus configured, the illumination light flux from the light source device 110 can be converted to an illumination light flux having more uniform intensity distribution, and the illuminated area can be illuminated at the uniform illuminance. Furthermore, an illumination light flux L is emitted which as a sectional form compressed in the longitudinal direction (the Y-axis direction) to illuminate the entire image forming area S in the transverse direction (the X-axis direction) of the image forming areas S of the liquid crystal devices 400R, 400G and 400B, and to partially illuminate the image forming area S in the longitudinal direction (the Y-axis direction) (see FIG. 1D).

At a position almost optically conjugated with each of the first small lenses 122 and the image forming areas S of the liquid crystal devices 400R, 400G and 400B, the position between the illuminating system 100 and the color separation light guide optical system 200, a light transmittance control member 700 as a light transmittance control module is disposed. As shown in FIG. 1D, the light transmittance control member 700 has a light transmitting control part 700a having “a rectangular plane form, the length in the Y-axis direction to the width in the X-axis direction □ 1:4”. Therefore, the light transmittance control member 700 has a function as a light shielding member which shapes the sectional form of the illumination light flux.

In addition, the detail of the light transmittance control member 700 will be described later.

The luminous flux emitted from the illuminating system 100 enters a rotating prism 770. The rotating prism 770 is disposed between the illuminating system 100 and the liquid crystal devices 400R, 400G and 400B, and has a function that scars with illumination light flux L over the image forming area S along the longitudinal direction (the Y-axis direction) in synchronization with the screen write frequencies of the liquid crystal devices 400R, 400G and 400B. Field lenses 790 and 792 disposed before and after the rotating prism 770 are disposed to effectively allow light to enter relay lenses 240 and 242, described later.

In addition, the detail of the rotating prism 770 will be described later.

As shown in FIG. 1A, the color separation light guide optical system 200 has dichroic mirrors 210 and 214, reflection mirrors 212,216,218,220 and 222, and the relay lenses 240 and 242. The color separation light guide optical system 200 has a function that separates the illumination light flux emitted from the rotating prism 770 into three color lights, red light, green light and blue light, and guides the individual color lights to the liquid crystal devices 400R, 400G and 400B to be illuminating targets. For the color separation light guide optical system 200, an equal optical path length optical system having equal optical path lengths from the illuminating system 100 to the liquid crystal devices 400R, 400G and 400B.

The dichroic mirror 210 transmits a red light component and a green light component in the light emitted from the rotating prism 770, and reflects a blue light component. The blue light component reflected at the dichroic mirror 210 is reflected at the reflection mirror 218, transmitted through the relay lens 242, reflected at the reflection mirrors 220 and 222, and transmitted through the field lens 248 to then reach the liquid crystal device 400B for the blue light. On the other hand, the red light component and the green light component transmitted through the dichroic mirror 210 are reflected at the reflection mirror 212 to pass through the relay lens 240. The red light component of the red light component and the green light component emitted from the relay lens 240 is transmitted through the dichroic mirror 214, reflected at the reflection mirror 216, and transmitted through the field lens 244 to reach the liquid crystal device 400R for red light. Moreover, the green light component reflected at the dichroic mirror 214 is reflected at the reflection mirror 218, and transmitted through the field lens 246 to reach the liquid crystal device 400G for green light. In addition, the field lenses 244,246 and 248 disposed before the optical path of each color light of the liquid crystal devices 400R, 400G and 400B are disposed to convert each of the partial light fluxes emitted from the second lens array 130 to the luminous flux almost in parallel with respect to each of the main light beams.

The liquid crystal devices 400R, 400G and 400B modulate the illumination light flux in accordance with image information to form a color image, which are the illuminating targets for the illuminating system 100. In addition, as omitted in the drawing, an incoming polarizing plate is interposed between the field lenses 244, 246 and 248 and each of the liquid crystal devices 400R, 400G and 400B, and an outgoing polarizing plate is interposed between each of the liquid crystal devices 400R, 400G and 400B and the cross dichroic prism 500. Light modulation is done for each incoming color light by the incoming polarizing plate, the liquid crystal devices 400R, 400G and 400B, and the outgoing polarizing plate.

The liquid crystal devices 400R, 400G and 400B are ones that have liquid crystals of an electrooptic material encapsulated in a pair of transparent glass substrates. For example, the devices use polysilicon TFTs as switching devices to modulate the polarization direction of one type of linear polarized light emitted from the incoming polarizing plate in accordance with an image signal supplied

For the liquid crystal devices 400R, 400G and 400B, a wide vision liquid crystal device having “a rectangular plane form, the length in the Y-axis direction to the width in the X-axis direction □9:16”.

The cross dichroic prism 500 is an optical device which combines an optical image modulated for each color light emitted from the outgoing polarizing plate to form a color image. The cross dichroic prism 500 has a nearly square seen in a plan, in which four rectangular prisms are bonded to each other, and a dielectric multilayer is formed on an almost X-shape interface that the rectangular prism are bonded to each other. The dielectric multilayer formed on one interface in an almost X-shape reflects red light, whereas the dielectric multilayer formed on the other interface reflects blue light. Red light and blue light are bent by the dielectric multilayers, and are formed to the travel direction of green light to combine three color lights.

The color image emitted from the cross dichroic prism 500 is magnified and projected by the projection optical system 600 to form a large screen image on the screen SCR.

The projector 1000 according to the first exemplary embodiment uses the rotating prism 770, and has the light transmittance control module.

Hereinafter, the rotating prism 770 and the light transmittance control module of the projector 1000 according to the first exemplary embodiment will be described in detail.

Rotating Prism

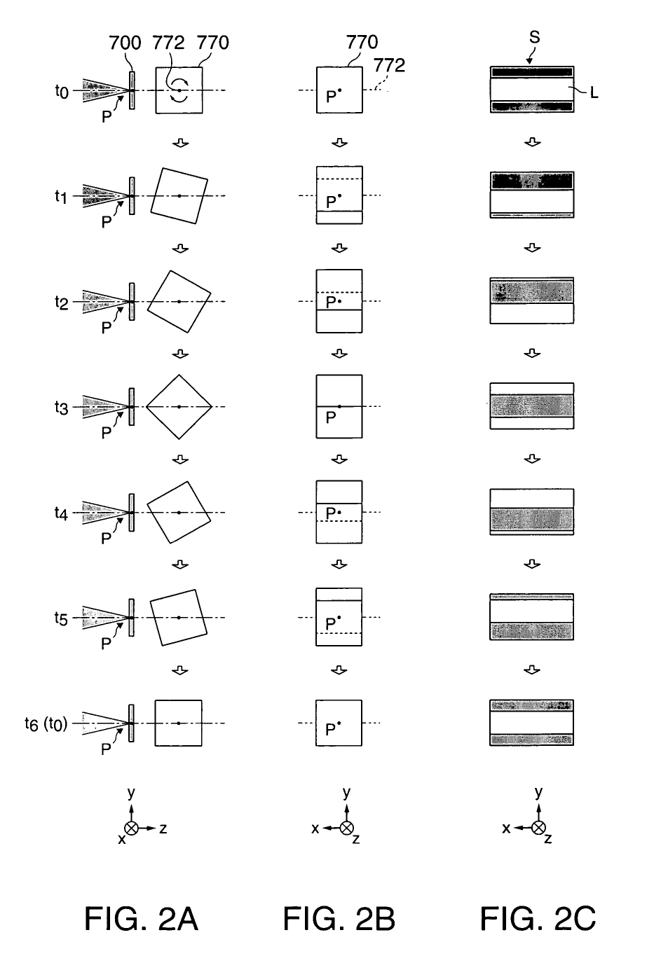

FIGS. 2A top 2C are diagrams illustrating the relationship between the rotation of the rotating prism 770 and the illuminating states on the liquid crystal devices 400R, 400G and 400B. FIG. 2A is cross sections when the rotating prism 770 is seen along the rotation axis 772. FIG. 2B is diagrams when the rotating prism 770 is seen along the illumination optical axis 100ax. FIG. 2C is diagrams illustrating the irradiating state of the illumination light flux L over the image forming areas S of the liquid crystal devices 400R, 400G and 400B.

The rotating prism 770 is configured to rotate at a constant speed in synchronization with screen write scan of the liquid crystal devices 400R, 400G and 400B. Therefore, as shown in FIGS. 2A to 2C, the light emitted from Image P at the phantom center point of the first small lenses 122 on the illumination optical axis 100ax receives a predetermined refraction due to the light transmission surface of the rotating prism 770 when the rotating prism 770 is rotated. Consequently, in the image forming areas S of the liquid crystal devices 400R, 400G and 400B, the light irradiating area and the nonirradiating area are sequentially scrolled as they are synchronized with screen write scan.

Therefore, according to the projector 1000 of the first exemplary embodiment, the rotating prism 770 is rotated so that the illumination light flux L scans over the image forming areas S of the liquid crystal devices 400R, 400G and 400B. Consequently, when attention is focused on a given point in the image forming areas S of the liquid crystal devices 400R, 400G and 400B, the light is intermittently blocked to improve the moving picture display quality and to provide the excellent moving picture display quality.

2. Light Transmittance Control Module

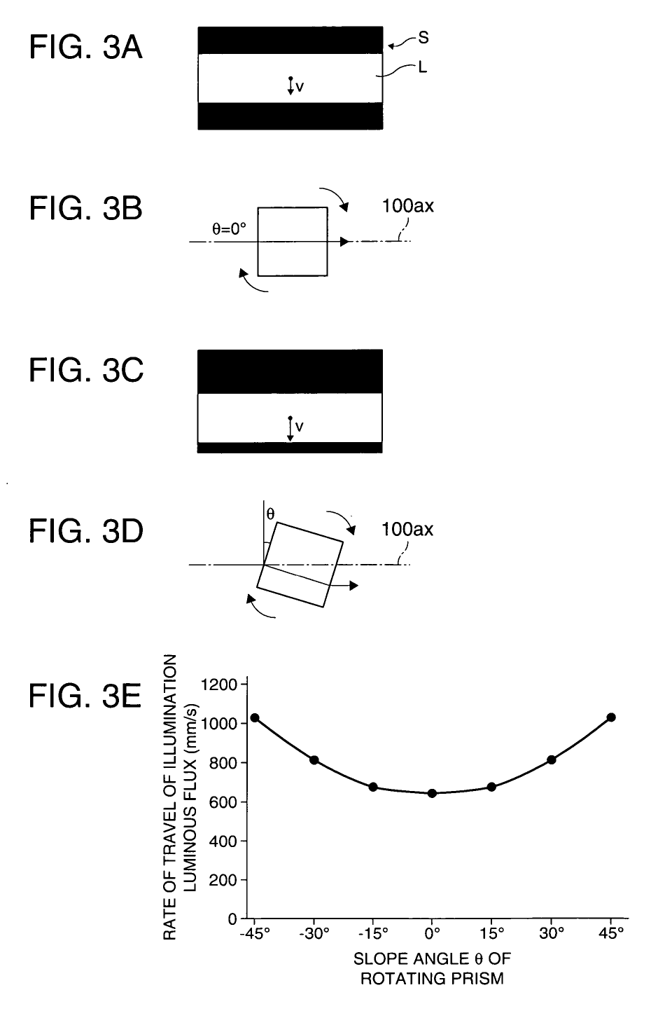

The projector 1000 according to the first exemplary embodiment has the light transmittance control module which changes a light transmittance of the illumination light flux so as to reduce the difference between the illuminance caused by changes in the scanning rate of the illumination light flux over the image forming areas S of the liquid crystal devices 400R, 400G and 400B. Furthermore, the light transmittance control module has the light transmittance control member 700, and a light transmittance control circuit 740 which controls the light transmittance of the light transmittance control member 700. Hereinafter, the light transmittance control member 700 and the light transmittance control circuit 740 will be described with reference to FIGS. 3 to 8.

FIGS. 3 to 7 are diagrams illustrative of the effect of the light transmittance control member 700 and the light transmittance control circuit 740.

FIGS. 3A to 3D are diagrams illustrating the illuminating state of the illumination light flux L in the image forming areas S of the liquid crystal devices 400R, 400G and 400B and the slope angle θ of the rotating prism 770. FIG. 3E is a diagram illustrating the relationship between the slope angle θ of the rotating prism 770 and the rate of travel of the illumination light flux L over the image forming area S. In addition, an arrow v shown in FIGS. 3A and 3C expresses the rate of travel in vector at the phantom center point the illumination light flux L. FIG. 3B shows the slope angle θ of the rotating prism 770 in the illuminating state shown in FIG. 3A (in the state that the illumination light flux L illuminates the longitudinal center part of the image forming area S). FIG. 3D shows the slope angle θ of the rotating prism 770 in the illuminating state shown in FIG. 3C (the illumination light flux L illuminates the longitudinal end part of the image forming area S).

In addition, in FIG. 3E, the slope angle θ of the rotating prism 770 is set to “the slope angle θ=0□” when the illumination optical axis 100ax vertically enters the surface of the rotating prism (hereinafter, the same in the specification).

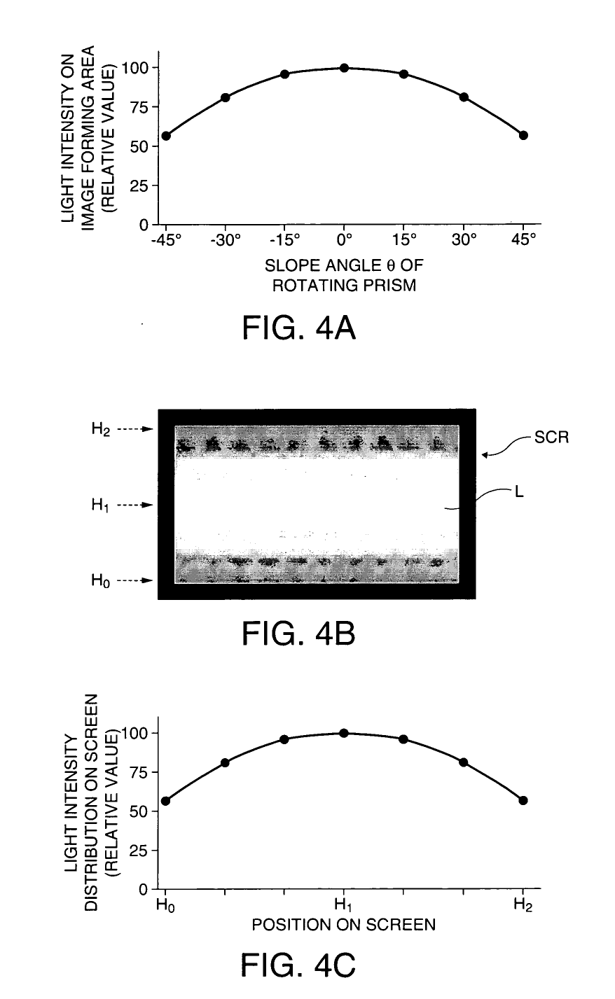

FIG. 4A is a diagram illustrating the relationship between the slope angle θ of the rotating prism 770 and the light intensity over the image forming area S in a projector according to a comparative example with no use of the light transmittance control module. FIG. 4B is a diagram illustrating the light intensity distribution on the screen SCR of the projector according to the comparative example. FIG. 4C is a diagram illustrating a relative value of the light intensity on the screen SCR of the projector according to the comparative example.

In the configuration in which the rotating prism 770 is rotated at a constant speed so that the illumination light flux L scans over the image forming areas S of the liquid crystal devices 400R, 400G and 400B, the rate of travel (the scanning rate) is varied depending on the position of the illumination light flux L over the image forming area S of the liquid crystal devices. More specifically, as shown in FIGS. 3A to 3E, the rate of travel of the illumination light flux at the both end parts in the longitudinal direction in the image forming area S is faster than the rate of travel of the illumination light flux at the longitudinal center part of the image forming area S. Therefore, in the projector according to the comparative example with no use of the light transmittance control module (not shown), as apparent from FIG. 4A, the illuminance at the both end parts in the longitudinal direction (the Y-axis direction) of the image forming area S is lower than the illuminance at the longitudinal center part in the liquid crystal devices 400R, 400G and 400B. Furthermore, as similar to the screen SCR, as shown in FIGS. 4B and 4C, the illuminance at the both end parts in the longitudinal direction (signs H₀,H₂) on the screen SCR is lower than the illuminance at the center part in the longitudinal direction (the Y-axis direction)(sign H₁).

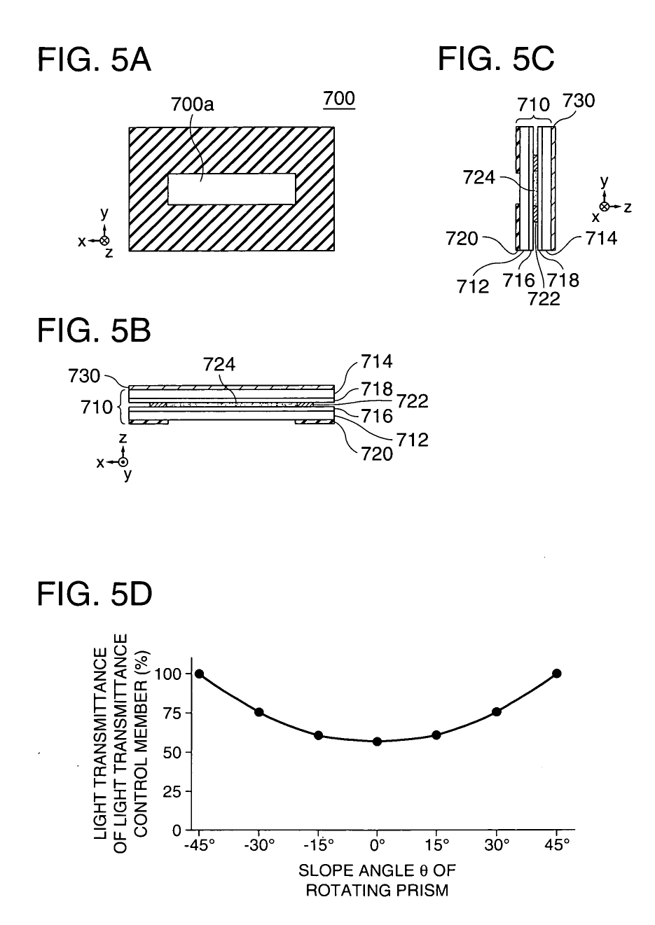

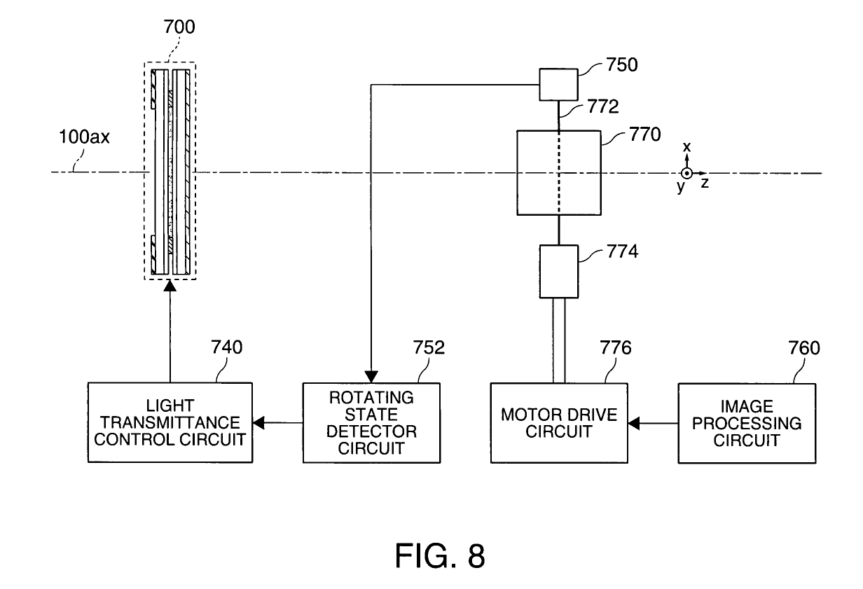

On the other hand, as shown in FIGS. 5 and 8, the projector 1000 according to the first exemplary embodiment has the light transmittance control member 700 as the high transmittance control module and the light transmittance control circuit 740.

FIG. 5A is a front view of the light transmittance control member 700. FIG. 5B is a cross section of the light transmittance control member 700 seen from the top. FIG. 5C is a cross section of the light transmittance control member 700 seen from the side. FIG. 5D is a diagram illustrating the relationship between the slop angle θ of the rotating prism 770 and the light transmittance of the light transmittance control member 700.

As shown in FIGS. 5B and 5C, the light transmittance control member 700 has a polarization direction control member 710 which controls the polarization direction of almost one type of linear polarized light depending on control by the light transmittance control circuit 740, and a polarizing plate 730 which transmits only the polarization component in the longitudinal direction (the Y-axis direction) in the illumination light flux emitted from the polarization direction control member 710.

The polarization direction control member 710 has the configuration in which transparent electrodes 716 and 718, a light shielding plate 720, and a spacer 722 are arranged between two transparent glass substrates 712 and 714, and liquid crystals 724 are encapsulated inside.

The polarizing plate 730 is disposed on the glass substrate 714 on the light emitting side of the polarization direction control member 710, which has a function to transmits the illumination light flux having the polarization component in the longitudinal direction (the Y-axis direction).

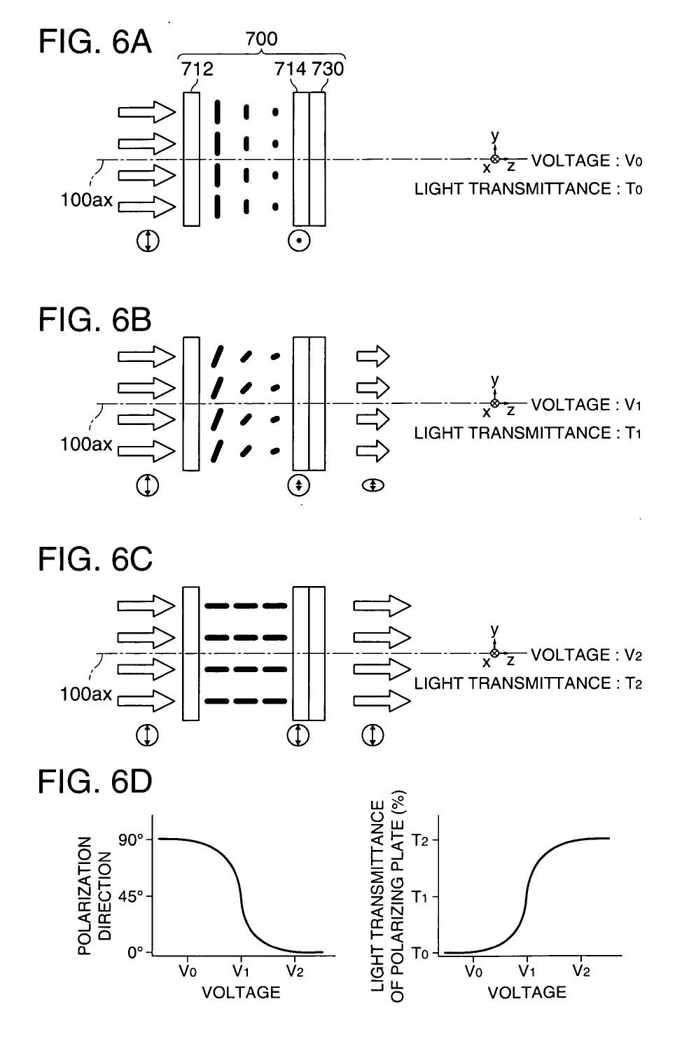

The light transmittance control member 700 has a function that varies voltage to be applied to the liquid crystals 724 of the polarization direction control member 710 to change the polarization direction of the illumination light flux passing through the polarization direction control member 710, and adjusts the light intensity of the illumination light flux to be absorbed at the polarizing plate 730 to then vary the rate of the light intensity of the illumination light flux emitted from the light transmittance control member 700 with respect to the light quantity of the illumination light flux entering the light transmittance control member 700 (hereinafter, called “the light transmittance of the light transmittance control member 700”). As shown in FIG. 5D, the light transmittance control member 700 controls the light transmittance in accordance with the slope angle θ of the rotating prism 770. Here changes in the light transmittance of the light transmittance control member 700 when voltage is applied to the liquid crystals 724 will be described with reference to FIGS. 6A to 6D.

FIGS. 6A to 6D are diagrams illustrative of changes in the light transmittance of the illumination light flux when voltage is applied to the liquid crystals 724 of the polarization direction control member 710. In addition, circled arrows in FIGS 6A to 6C depict polarization components in parallel with the paper surface.

An example will be taken and described that the illumination light flux having the polarization light flux the longitudinal direction (the Y-axis direction) enters the light transmittance control member 700. When voltage V₀ is applied to the liquid crystals 724 of the polarization direction control member 710, as shown in FIG. 6A, the polarization direction of the illumination light flux having the polarization component in the longitudinal direction (the Y-axis direction) to enter the light transmittance control member 700 is rotated by an angle of 90□ in passing through the polarization direction control member 710, and the illumination light flux becomes the illumination light flux having the polarization component in the transverse direction (the X-axis direction). Since the polarizing plate 730 is disposed on the light emitting side of the polarization direction control member 710, the illumination light flux having the polarization component in the transverse direction (the X-axis direction) is absorbed at the polarizing plate 730 and the illumination light flux is not emitted from the light transmittance control member 700. More specifically, when voltage V₀ is applied to the liquid crystals 724 of the polarization direction control member 710, as shown in FIG. 6D, the light transmittance control member 700 has a light transmittance T₀.

On the other hand, when voltage V₂ is applied to the liquid crystals 724 of the polarization direction control member 710, as shown in FIG. 6C, the illumination light flux having the polarization component in the longitudinal direction (the Y-axis direction) to enter the light transmittance control member 700 passes through the polarizing plate 724 as it is without changing the polarization direction at the polarization direction control member 710. More specifically, when voltage V₂ is applied to the liquid crystals 724 of the polarization direction control member 710, as shown in FIG. 6D, the light transmittance control member 700 has a light transmittance T₂.

Furthermore, when voltage V₁ is applied to the liquid crystals 724 of the polarization direction control member 710, as shown in FIG. 6B, the polarization direction of the illumination light flux having the polarization component in the longitudinal direction (the Y-axis direction) to enter the light transmittance control member 700 is rotated by an angle of about 45□ in passing through the polarization direction control member 710 to become the illumination light flux having the polarization component in the oblique direction. Since the illumination light flux having the polarization component in the transverse direction (the X-axis direction) in the illumination light flux having the polarization component in the oblique direction is absorbed at the polarizing plate 730, the illumination light flux having about 50 of the light quantity is emitted from the light transmittance control member 700 as compared with the high quantity of the illumination light flux that is emitted when voltage V2 is applied to the liquid crystals 724. More specifically, when voltage V₁ is applied to the liquid crystals 724 of the polarization direction control member 710, as shown in FIG. 6D, the light transmittance control member 700 has a light transmittance T₁.

As described above, the light transmittance control member 700 is configured in which the voltage applied to the liquid crystals 724 of the polarization direction control member 710 is varied to change the light transmittance of the light transmittance control member 700.

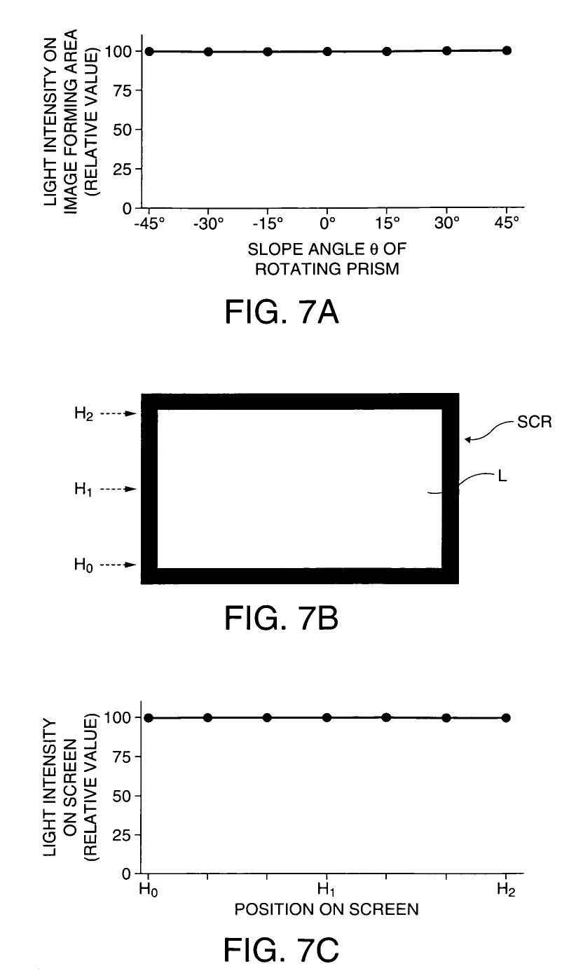

FIG. 7A is a diagram illustrating the relationship between the slope angle of the rotating prism 770 and the light intensity over the image forming area S of the projector 1000 according to the first exemplary embodiment. FIG. 7B is a diagram illustrating the light intensity distribution on the screen SCR of the projector 1000 according to the first exemplary embodiment. FIG. 7C is a diagram illustrating the relative value of the light intensity on the screen SCR of the projector 1000 according to the first exemplary embodiment. In addition, in FIGS. 7A and 7C, for the light intensity of each slope angle θ, the light intensity is 100, where the slope angle θ□0□, showing the relative value with respect to the light intensity.

As also apparent from FIGS. 4A and 5D, the light transmittance control circuit 740 has a function that controls voltage to be applied to the polarization direction control member 710 so that the light transmittance of the light transmittance control member 700 is reduced when the illumination light flux L passes through the center part in the longitudinal direction (the Y-axis direction) of the image forming area S of the liquid crystal devices 400R, 400G and 400B, and that controls voltage to be applied to the polarization direction control member 710 so that the light transmittance of the light transmittance control member 700 is increased when the illumination light flux L passes through the both end parts in the longitudinal direction (the Y-axis direction) of the image forming areas S of the liquid crystal devices 400R, 400G and 400B. More specifically, the light transmittance control circuit 740 has a function that adjusts voltage to be applied to the polarization direction control member 710 so as to reduce the difference between the illuminance caused by changes in the rate of travel of the illumination light flux L (the scanning rate) over the image forming areas S of the liquid crystal devices 400R, 400G and 400B, and that controls the light transmittance of the light transmittance control member 700.

Therefore, according to the projector 1000 of the first exemplary embodiment, as shown in FIG. 7A, the difference between the illuminance which occurs when the rotating prism 710 is rotated at a constant rotation speed is reduced, and as shown in FIG. 7B and 7C, uniform display can be done throughout the screen SCR. More specifically, the projector has uniform in-plane display properties.

FIG. 8 is a block diagram illustrative of the light transmittance control member 700 and the light transmittance control circuit 740 in the projector 1000 according to the first exemplary embodiment.

As shown in FIG. 8, the projector 1000 according to the first exemplary embodiment further has a rotating state sensor 750 which senses the rotating state of the rotating prism 770, and a rotating state detector circuit 752 which processes an output signal of the rotating state sensor 750 and outputs it to the light transmittance control circuit 740. The light transmittance control circuit 740 is configured to control the light transmittance of the light transmittance control member 700 based on the output signal of the rotating state detector circuit 752.

Thus, according to the projector 1000 of the first exemplary embodiment, reliable control corresponding to the rotating state of the rotating prism 770 can be done. Therefore, the difference between the illuminance caused by changes in the rate of travel of the illumination light flux (the scanning rate) over the image forming areas S of the liquid crystal devices 400R, 400G and 400B can be effectively reduced.

In addition, the projector 1000 according to the first exemplary embodiment is configured in which based on the output signal from an image processing circuit 760 which processes image information, the motor drive circuit 776 drives the motor 774 to rotate the rotating prism 770 in synchronization with the screen write frequencies of the liquid crystal devices 400R, 400G and 400B.

As described above, the projector 1000 according to the first exemplary embodiment has the polarization conversion device 140 which rearranged the illumination light flux into almost one type of linear polarized light, and the light transmittance control member 700 has the polarization direction control member 710 and the polarizing plate 730. Therefore, control by the light transmittance control circuit 740 changes voltage to be applied to the liquid crystals 724 of the polarization direction control member 710 to change the polarization direction of the illumination light flux passing through the polarization direction control member 710, and the light quantity of the illumination light flux can be adjusted that is absorbed at the polarizing plate 730. Thus, the light transmittance of the illumination light flux can be accurately controlled at low power consumption.

In the projector 1000 according to the first exemplary embodiment, the polarization direction control member 710 (the light transmittance control member 700) is disposed at the position almost optically conjugated with each of the first small lenses 122 and the image forming areas S of the liquid crystal devices 400R, 400G and 400B.

In the projector according to an exemplary embodiment of the invention, the polarization direction control member can be disposed at any places as long as the place is in the optical path through which the illumination light flux passes. However, at the position almost optically conjugated with each of the first small lenses 122 and the image forming areas S of the liquid crystal devices 400R, 400G and 400B, the cross-sectional area of the illumination light flux becomes small. Therefore, as describe above, the polarization direction control member 710 is disposed at this place to reduce the size of the polarization direction control member 710 and to decrease fabrication costs.

As described above, in the projector 1000 according to the first exemplary embodiment, the light transmittance control module has the light transmittance control circuit 740 which controls the light transmittance of the light transmittance control member 700 and the light transmittance control member 700. Thus, it can be implemented easily to accurately control the light transmittance of the illumination light flux so as to reduce the difference between the illuminance.

In the projector 1000 according to the first exemplary embodiment, the polarization direction control member 710 (the light transmittance control member 700) further has the function as the light shielding member which shapes the sectional form of the illumination light flux. Therefore, the sectional form of the illumination light flux emitted from the polarization direction control member 710 can be correctly shaped into the sectional form of the illumination light flux L to be irradiated onto the image forming areas S of the liquid crystal devices 400R, 400G and 400B.

As described above, according to the projector 1000 of the first exemplary embodiment, the rotation speed of the rotating prism does not need to be varied in a very short period. Thus, an expensive motor does not need to be used for the motor to drive the rotating prism as well as the rotation speed of the motor to drive the rotating prism also does not need to be frequently increased and reduced. Therefore, increases in fabrication costs and in power consumption can be eliminated.

Thus, according to the projector 1000 of the first exemplary embodiment, a projection can be fabricated which has excellent moving picture display quality and uniform in-plane display properties with no increase neither in fabrication costs nor in power consumption.

As described above, the rotating prism 770 and the light transmittance control module of the projector 1000 according to the first exemplary embodiment have been described in detail. The projector 1000 according to the first exemplary embodiment also has the following characteristics.

In the projector 1000 according to the first exemplary embodiment, the light source device 110 is the light source device which as the arc tube 112, the ellipsoidal reflector 114 which reflects the light from the arc tube 112 and the parallel lens 118 which forms the light reflected at the ellipsoidal reflector 114 into almost parallel light.

Therefore, according to the projector 1000 of the first exemplary embodiment, a more compact light source device than a light source device using a parabolic reflector can be implemented.

In the projector 1000 according to the first exemplary embodiment, the arc tube 112 is provided with the auxiliary mirror 116 which reflects the light emitted from the arc tube 112 on the illuminated area side toward the arc tube 112.

Therefore, according to the projector 1000 of the first exemplary embodiment, the light radiated from the arc tube 112 to the illuminated area side is reflected toward the arc tube 112. Thus, the size of the ellipsoidal reflector 114 does not need to be set to the size that covers the end part on the illuminated area side of the arc tube 112, the ellipsoidal reflector 114 can be reduced in size, and the projector 1000 can be reduced in size. Furthermore, this means that the size of the first lens array 120, the size of the second lens array 130, the size of the polarization conversion device 140, the size of the superposing lens 150, the size of color separation optical system 200, etc., can be further reduced, allowing a further reduction in size of the projector 1000.

In the projector 1000 according to the first exemplary embodiment, the three liquid crystal devices 400R, 400G and 400B are provided as the electrooptic modulator, which modulate three color lights emitted from the color separation light guide optical system 200 in accordance with image information corresponding to the individual color lights. Moreover, the projector further has the color separation light guide optical system 200 which is disposed between the rotating prism 770 and the liquid crystal devices 400R, 400G and 400B and separates the illumination light flux from the rotating prism 770 into three color lights to guide them to the liquid crystal devices 400R, 400G and 400B, and the cross dichroic prism 500 which combines the individual color lights modulated at the liquid crystal devices 400R, 400G and 400B.

Therefore, according to the projector 1000 of the first exemplary embodiment, even though a projector is formed to obtain smooth, excellent moving image display, a three-plate full-color projector can be formed with excellent image quality in which light efficiency of use is not reduced greatly.

In the projector 1000 according to the first exemplary embodiment, the polarization conversion device 140 is further provided to form the illumination light flux from the light source device 110 to one type of linear polarized light and emit it.

Therefore, the operation of the polarization conversion device 140 can convert the illumination light flux from the light source device 110 to one type of linear polarized light having one of the polarized axes. Thus, in the case of using an electrooptic modulator such as the liquid crystal device using one type of linear polarized light as the electrooptic modulator like the projector 1000 according to the first exemplary embodiment, the illumination light flux from the light source device 110 can be used effectively.

In the projector 1000 according to the first exemplary embodiment, an anti-reflection film is formed on the light transmission surface of the rotating prism 770. Therefore, the light transmittance of the rotating prism 770 is improved to minimize a reduction in light efficiency of use as well as the stray light level is decreased to enhance contrast.

### Second Exemplary Embodiment

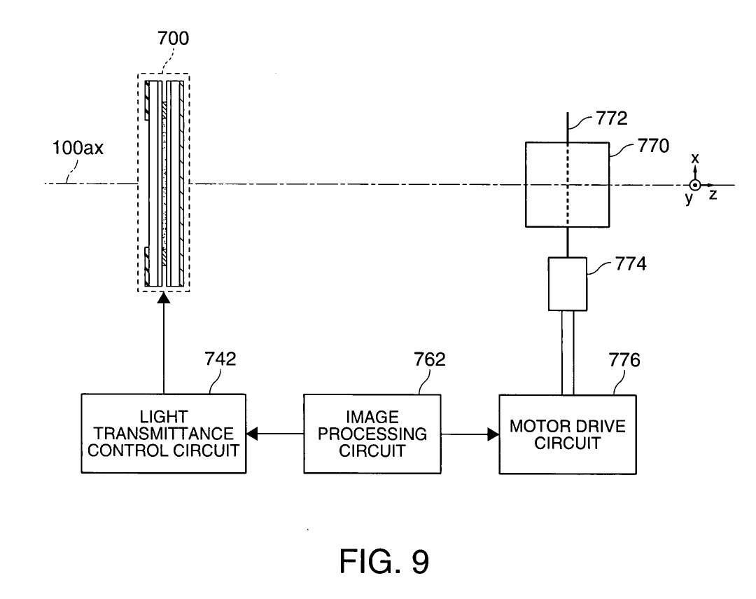

FIG. 9 is a diagram illustrative of a projector 1002 according to the second exemplary embodiment. In addition, in FIG. 9, the same numerals and signs are assigned to the same members as those of FIG. 8, omitting detailed descriptions.

Although the projector 1002 according to the second exemplary embodiment (not shown) basically has the configuration closely analogous to that of the projector 1000 according to the first exemplary embodiment, as shown in FIG. 9, the difference from the projector 1000 according to the first exemplary embodiment, as shown in FIG. 9, the difference from the projector 1000 according to the first exemplary embodiment is in that a control module of the light transmittance control circuit is varied.

More specifically, the projector 1000 according to the first exemplary embodiment uses the rotating state sensor 750 as the control module, which senses the rotating state of the rotating prism 770 (see FIG. 8). The light transmittance control circuit 740 is configured to control the light transmittance of the light transmittance control member 700 based on the output signal of the rotating state sensor 750.

On the other hand, the projector 1002 according to the second exemplary embodiment uses an image processing circuit 762 as the control module, which processes image information, instead of the rotating state sensor, as shown in FIG. 9. A light transmittance control circuit 742 is configured to control the light transmittance of a light transmittance control member 700 based on the synchronization signal from the image processing circuit 762.

IN the projector 1002 according to the second exemplary embodiment, control of the light transmittance of the light transmittance control member 700 and the rotation of a rotating prism 770 are both based on the synchronization signal from the image processing circuit 762. Therefore, also with the configuration as described above, reliable control of the light transmittance of the light transmittance control member 700 can be done as it corresponds to the rotating state of the rotating prism 770. Thus, the difference between the illuminance caused by charges in the scanning rate of the illumination light flux over the image forming area of the liquid crystal devices 400R, 400G and 400B can be reduced effectively.

As described above, the projector 1002 according to the second exemplary embodiment is different from the projector 1000 according to the first exemplary embodiment in that the control module of the light transmittance control circuit is varied which reduces the difference between the illuminance caused by changes in the rate of travel of the illumination light flux (the scarring rate) over the image forming area of the liquid crystal device. However, as similar to the case of the projector 1000 according to the first exemplary embodiment, the light transmittance control member 700 is provided as the light transmittance control module and the light transmittance control circuit 742 is provided to control the light transmittance of the light transmittance control member 700. Therefore, the difference between the illuminance can be reduced which occurs when the rotating prism 770 is rotated at a constant rotation speed, and more uniform display can be done throughout the screen. More specifically, uniform in-plane display properties are provided.

Accordingly, the projector 1002 according to the second exemplary embodiment has the same configuration as that of the projector 1000 according to the first exemplary embodiment except the control module of the light transmittance control circuit, having the same effect as that of the projector 1000 according to the first exemplary embodiment.

### Third Exemplary Embodiment

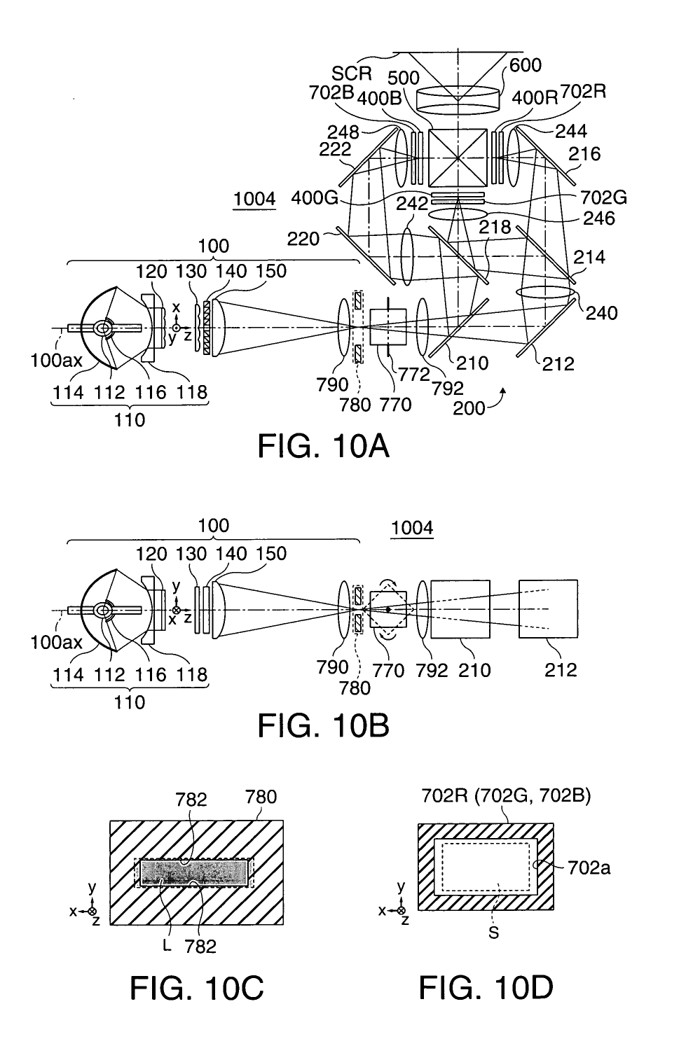

FIGS. 10A to 10D are diagrams illustrative of a projector 1004 according to a third exemplary embodiment. FIG. 10A is a diagram of an optical system of the projector 1004 seen from the top. FIG. 10B is a diagram of the optical system of the projector 1004 seen from the side. FIG. 10C is a front view of a light shielding member 780. FIG. 10D is a front view of a light transmittance control member 702R.

Although the projector 1004 according to the third exemplary embodiment basically has the configuration closely analogous to the project or 1000 according to the first exemplary embodiment, as shown in FIG. 10A, it is different from the projector 1000 according to the first exemplary embodiment in the arranging position, numbers and structure of a light transmittance control member.

More specifically, as shown in FIGS. 10A and 10B, in the projector 1004 according to the third exemplary embodiment, three light transmittance control members 702R, 702G and 702B are disposed on the incident side of liquid crystal devices 400R, 400G and 400B, respectively. Since the light transmittance control members 702R, 702G and 702B are disposed very close to the liquid crystal devices 400R, 400G and 400B, a light transmitting part 702a of each of the light transmittance control members 702R, 702G and 702B has a shape closely similar to an image forming area S as shown in FIG. 10D, different from the light transmitting part 700a of the light transmittance control member 700 (see FIG. 5A) described in the first exemplary embodiment. However, the light transmittance control members 702R, 702G and 702B have almost the same configuration as that of the light transmittance control member 700 described in the first exemplary embodiment except for the above described, omitting detailed descriptions.

Furthermore, at the position almost optically conjugated with each of the first small lens and the image forming area S of the liquid crystal devices 400R, 400G and 400B, a light shielding member 780 is disposed which shapes the sectional form of the illumination light flux. As shown in FIG. 10C, the light shielding member 780 has an opening 782 with “a rectangular plane form, the length in the Y-axis direction to the width in the X-axis direction □ 1:4.”

As described above, the projector 1004 according to the third exemplary embodiment is different from the projector 1000 according to the first exemplary embodiment in the arranging position, numbers and structure of the light transmittance control member (correspondingly, it has the light shielding member 780). However, as similar to the case of the projector 1000 according to the first exemplary embodiment, the light transmittance control members 702R, 702G and 702B are provided as the light transmittance control module, and a light transmittance control circuit (not shown) is provided to control the light transmittance of the light transmittance control members 702R, 702G and 702B based on the output signal of a rotating state sensor (not shown). Thus, the difference between the illuminance is reduced which occurs when the rotating prism 770 is rotated at a constant rotation speed, and more uniform display can be done throughout the screen SCR. More specifically, uniform in-plane display properties are provided.

In addition, in the projector 1004 according to the third exemplary embodiment, as described above, it is configured to have the light transmittance control circuit which controls the light transmittance of the light transmittance control members 702R, 702G and 702B based on the output signal of the rotating state sensor. However, as similar to the case of the projector 1002 according to the second exemplary embodiment, it may be configured to have a light transmittance control circuit which controls the light transmittance of the light transmittance control members 702R, 702G and 702B based on the synchronization signal from the image processing circuit.

Accordingly, the projector 1004 according to the third exemplary embodiment has the same configuration as that of the projector 1000 or 1002 according to the first or second exemplary embodiment except the arranging position, numbers and structure of the light transmittance control member (correspondingly, it has the light shielding member 780), thus having the same effect as that of the projector 1000 or 1002 according to the first or second exemplary embodiment.

### Fourth Exemplary Embodiment

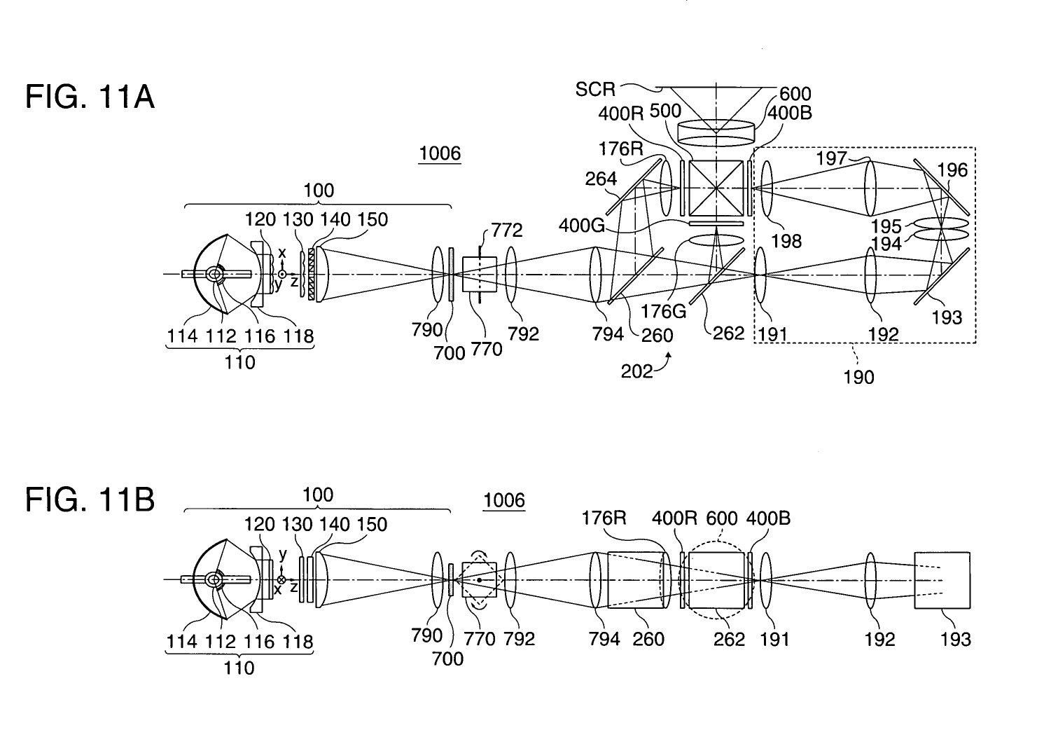

FIGS. 11A and 11B are diagrams illustrating an optical system of a projector 1006 of a fourth exemplary embodiment. FIG. 11A is a diagram of the optical system of the projector 1006 seen from the top. FIG. 11B is a diagram of the optical system of the projector 1006 seen from the side.

The projector 1006 of the fourth exemplary embodiment basically has the configuration closely analogous to the projector 1000 according to the first exemplary embodiment. However, as shown in FIG. 11A, it is different from the projector 1000 according to the first exemplary embodiment in that the configuration of a color separation light guide optical system is varied.

More specifically, in the projector 1006 of the fourth exemplary embodiment, for a color separation light guide optical system 202, a double relay optical system 190 is used to arrange in the same directions the directions to scroll the light irradiating area and the nonirradiating area on each of liquid crystal devices 400R, 400G and 400B.

As shown in FIG. 11A, the color separation light guide optical system 202 has dichroic mirrors 260 and 262, a reflection mirror 264, and the double relay optical system 190. The double relay optical system 190 has relay lenses 191, 192, 194, 195, and 197, reflection mirrors 193 and 196, and a field lens 198. Furthermore, a relay lens 794 is disposed before the optical path of the color separation light guide optical system 202.

The dichroic mirror 260 reflects the red light component in the light emitted from the rotating prism 770, and transmits the green light component and the blue light component. The red light component reflected at the dichroic mirror 260 is reflected at the reflection mirror 264, and it passes through the field lens 176R to reach the liquid crystal device 400R for red light.

The green light component of the green light component and the blue light component transmitted through the dichroic mirror 260 is reflected at the dichroic mirror 262, and it passes through a field lens 176G to reach the liquid crystal device 400G for green light. On the other hand, the blue light component transmitted through the dichroic mirror 260 is transmitted through the dichroic mirror 262, and it passes through the double relay optical system 190 to reach the liquid crystal device 400B for blue light. The field lenses 176R, 176G and 198 disposed before the optical path of each color light of the liquid crystal devices 400R, 400G and 400B are disposed to convert each of the partial light fluxes emitted from a second lens array 130 to the luminous flux almost in parallel with each of the main light beam.

Here, the reason why the double relay optical system 190 is disposed on the blue light optical path is that since the length of the blue light optical path is longer than the length of the optical paths of the other color lights, a reduction in efficiency of use of light is prevented because of light divergence, etc., and the directions to scroll the light irradiating area and the nonirradiating area are arranged in the same direction on each of the liquid crystal devices 400R, 400G and 400B. In addition, in the projector 1006 of the fourth exemplary embodiment, it is configured to use the double relay optical system 190 for the blue light optical path among three color lights, but it may be configured to use the double relay optical system like this for the optical path of the other color lights such as red light.

As described above, the projector 1006 of the fourth exemplary embodiment is different from the projector 1000 according to the first exemplary embodiment in the configuration of the color separation light guide optical system. However, as similar to the case of the projector 1000 according to the first exemplary embodiment, the light transmittance control member 700 is provided as the light transmittance control module, and the light transmittance control circuit (not shown) is provided to control the light transmittance of the light transmittance control member 700 based on the output signal of the rotating state sensor (not shown). Therefore, the difference between the illuminance is reduced which occurs when the rotating prism 770 is rotated at a constant rotation speed, and more uniform display can be done throughout the screen SCR. More specifically, uniform in-plane display properties are provided.

In addition, as described above, in the projector 1006 of the fourth exemplary embodiment, it is configured to have the light transmittance control circuit which controls the light transmittance of the light transmittance control member 700 based on the output signal of the rotating state sensor. However, as similar to the case of the projector 1002 according to the second exemplary embodiment, it may be configured to have a light transmittance control circuit which control the light transmittance of the light transmittance control member 700 based on the synchronization signal from the image processing circuit.

Accordingly, the projector 1006 of the fourth exemplary embodiment has the same configuration as that of the projector 1000 or 1002 according to the first or second exemplary embodiment except the configuration of the color separation light grade optical system, thus having the same effect as that of the projector 1000 or 1002 according to the first or second exemplary embodiment.

### Fifth Exemplary Embodiment

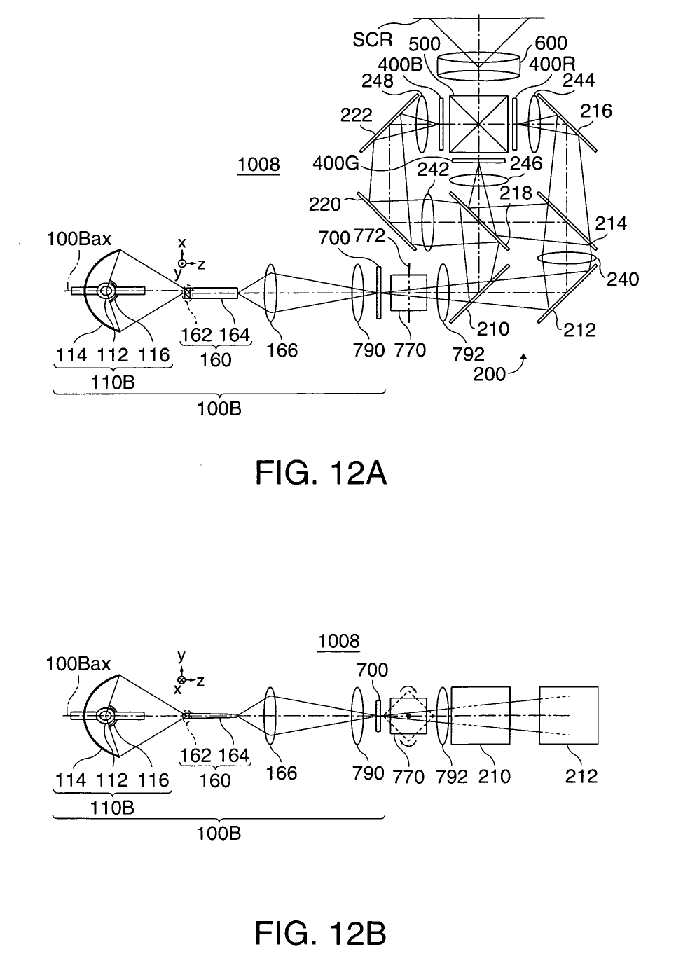

FIGS. 12A and 12B are diagrams illustrating an optical system of a projector 1008 according to a fifth exemplary embodiment. FIG. 12A is a diagram of the optical system of the projector 1008 seen from the top. FIG. 12B is a diagram of the optical system of the projector 1008 seen from the side.

The projector 1008 according to the fifth exemplary embodiment has basically has the configuration closely analogous to the projector 1000 according to the first exemplary embodiment. However, as shown in FIGS. 12A and 12B, it is different from the projector 1000 according to the first exemplary embodiment in that the configuration of an illuminating system is varied.

More specifically, in the projector 1008 according to the fifth exemplary embodiment, a rod integrator optical system is used for an illuminating system 100B.

The illuminating system 100B has a light source device 110B which emits a converging illumination light flux to the illuminated area side, an integrator rod 160 which converts the illumination light flux from the light source device 110B to an illumination light flux having more uniform intensity distribution and illuminates the illuminated area at the uniform illuminance, and a relay lens 166. At the position almost optically conjugated with the light emitting plane of the integrator and 160 and the image forming area of liquid crystal devices 400R, 400G and 400B, a light transmittance control member 700 is disposed.

The integrator rod 160 has a polarization converting part 162 which rearranges the illumination light flux in the nonuniform polarization directions emitted from the light source device 110B into one type of linear polarized light, and a rod part 164. The polarization converting part 162 has a polarization separation layer which transmits one linear polarized light component of polarization components contained in the illumination light flux from the light source device 110B as it is and reflects the other linear polarized light component in the direction vertical to an illumination optical axis 100Bax, a reflective layer which reflects the other linear polarized light component reflected at the polarization separation layer in the direction in parallel with the illumination optical axis 100Bax, and a retardation film which does polarization conversion so as to rearrange a linear polarized light component into one of the linear polarized light component having passed through the polarization separation layer and the other linear polarized light component reflected at the reflective layer.

The light emitting plane of the integrator rod 160 has “a vertically compressed rectangular plane form, the length in the Y-axis direction to the width in the X-axis direction □ 1:4.”

As described above, the projector 1008 according to the fifth exemplary embodiment is different from the projector 1000 according to the first exemplary embodiment in the configuration of the illuminating system. However, as similar to the case of the projector 1000 according to the first exemplary embodiment, the light transmittance control member 700 is provided as the light transmittance control module and the light transmittance control circuit is provided to control the light transmittance of a light transmittance control member 700 (not shown) based on the output signal of the rotating state sensor (not shown). Therefore, the difference between the illuminance is reduced which occurs when the rotating prism 770 is rotated at a constant rotation speed, and more uniform display can be done throughout the screen SCR. More specifically, uniform in-plane display properties are provided.

In addition, as described above, in the projector 1008 according to the fifth exemplary embodiment, it is configured to have the light transmittance control circuit which controls the light transmittance of the light transmittance control member 700 based on the output signal of the rotating state sensor. However, as similar to the case of the projector 1002 according to the second exemplary embodiment, it may be configured to have a light transmittance control circuit which controls the light transmittance of the light transmittance control member 700 based on the synchronization signal from the image processing circuit.

Accordingly, the projector 1008 according to the fifth exemplary embodiment has the same configuration as that of the projector 1000 or 1002 according to the first or second exemplary embodiment except the configuration of the illuminating system, thus having the same effect as that of the projector 1000 or 1002 according to the first or second exemplary embodiment.

### Sixth Exemplary Embodiment

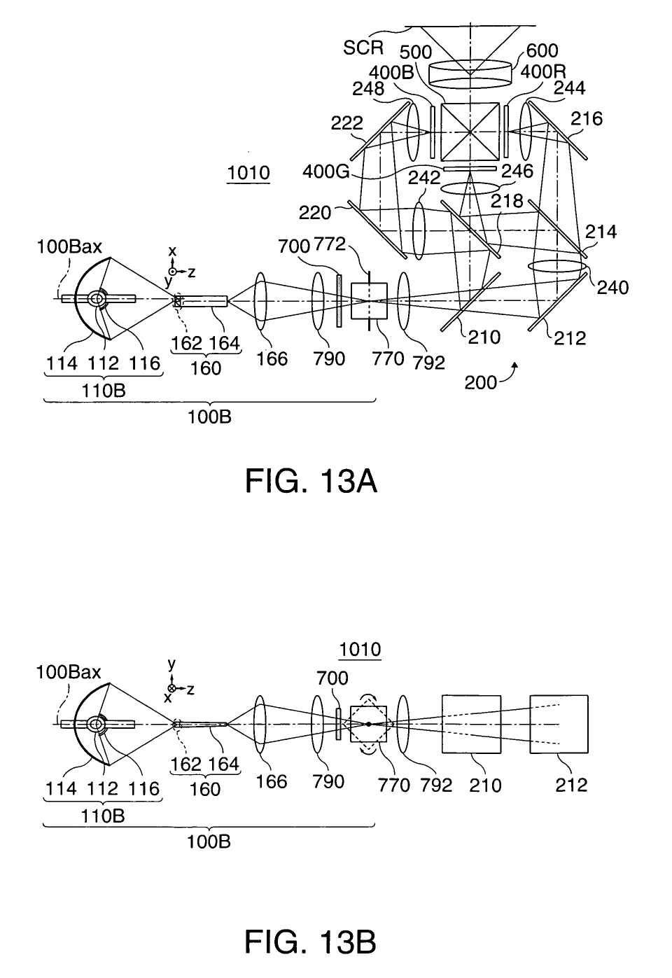

FIGS. 13A and 13B are diagrams illustrating an optical system of a projector 1010 according to a sixth exemplary embodiment. FIG. 13A is a diagram of the optical system of the projector 1010 seen from the top. FIG. 13B is a diagram of the optical system of the projector 1010 seen from the side.

The projector 1010 according to the sixth exemplary embodiment basically has the configuration closely analogous to that of the projector 1008 according to the fifth exemplary embodiment. However, as shown in FIGS. 13A and 13B, it is different from the projector 1008 according to the fifth exemplary embodiment in that the arranging position of a rotating prism is varied (correspondingly, the arranging position of a light transmittance control member is varied).

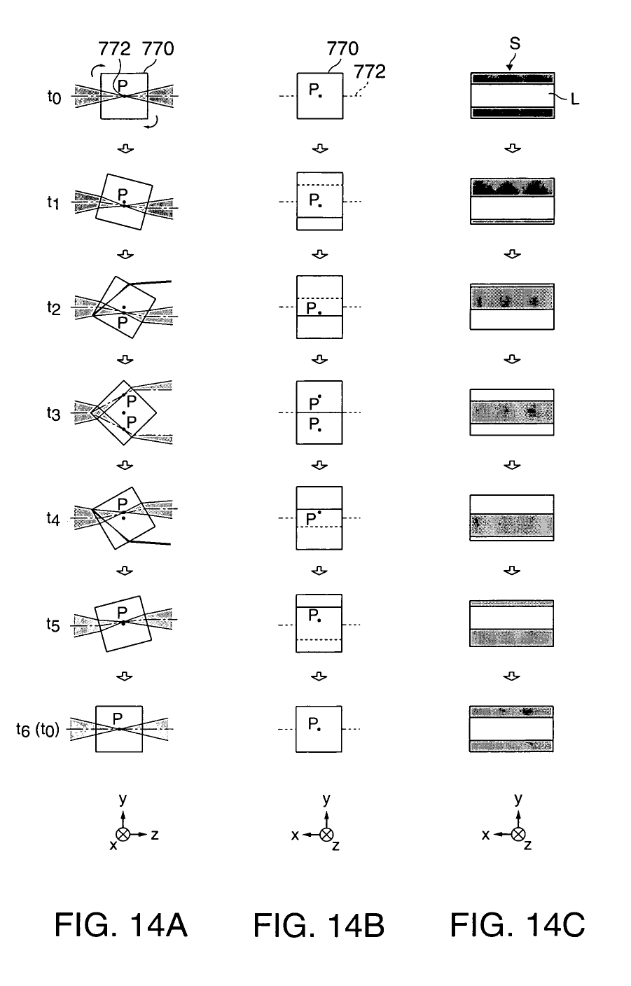

More specifically, in the projector 1010 according to the sixth exemplary embodiment, a rotating prism 770 is disposed at the position almost optically conjugated with the light emitting plane of an integrator and 160 and the image forming areas S of liquid crystal devices 400R, 400G and 400B (see FIG. 14C). Furthermore, correspondingly, a light transmittance control member 700 is disposed at the position between a field lens 790 and the rotating prism 770 and slightly separated from the position almost optically conjugated with the light emitting plane of the integrator rod 160 and the image forming areas S of the liquid crystal devices 400R, 400G and 400B.

FIGS. 14A to 14C are diagrams illustrating the relationship between the rotation of the rotating prism 770 and the illuminating states on the liquid crystal devices 400R, 400G and 400B. FIG. 14A is cross sections of the rotating prism 770 seen along a rotation axis 772. FIG. 14B is diagrams of the rotating prism 770 seen along the illumination optical axis 100Bax. FIG. 14C is diagrams illustrating the irradiating state of the illumination light flux L over the image forming areas S of the liquid crystal devices 400R, 400G and 400B.

The rotating prism 770 is configured to rotate at a constant speed in synchronization with screen write scan of the liquid crystal devices 400R, 400G and 400B. Therefore, as shown in FIGS. 14A to 14C, the light emitted from Image P at the phantom center point of the light emitting plane of the integrator and 160 on the illumination optical axis 100Bax receives a predetermined refraction due to the light transmission surface of the rotating prism 770 when the rotating prism 770 is rotated. Consequently, on the image forming areas S of the liquid crystal devices 400R, 400G and 400B, the light irradiating area and the nonirradiating area are sequentially scrolled in synchronization with screen write scan.

Therefore, according to the projector 1010 of the sixth exemplary embodiment, as similar to the base of the projector 1008 according to the fifth exemplary embodiment, the rotating prism 770 is rotated so that the illumination light flux L scans over the image forming areas S of the liquid crystal devices 400R, 400G and 400B. Consequently, when attention is focused on a given point in the image forming areas S of the liquid crystal devices 400, 400G and 400B, light is intermittently blocked to improve the moving picture display quality, the and excellent moving picture display quality are provided.

As described above, the projector 1010 according to the sixth exemplary embodiment is different from the projector 1008 according to the fifth exemplary embodiment in that the arranging position of the rotating prism is varied (correspondingly, the arranging position of the light transmittance control member is varied). However, as similar to the case of the projector 1008 according to the fifth exemplary embodiment, the light transmittance control member 700 is provided as the light transmittance control module, and the light transmittance control circuit is provided to control the light transmittance of the light transmittance control member 700 (not shown). Thus, the difference between the illuminance caused when the rotating prism 770 is rotated at a constant rotation speed is reduced, and more uniform display can be done throughout the screen SCR. More specifically, uniform in-plane display properties are provided.

Therefore, according to the projector 1010 of the sixth exemplary embodiment, a projector can be formed which has the same effect as that of the projector 1008 according to the fifth exemplary embodiment, and has excellent moving picture display quality and uniform in-plane display properties with no increase in fabrication costs nor in power consumption.

### Seventh Exemplary Embodiment

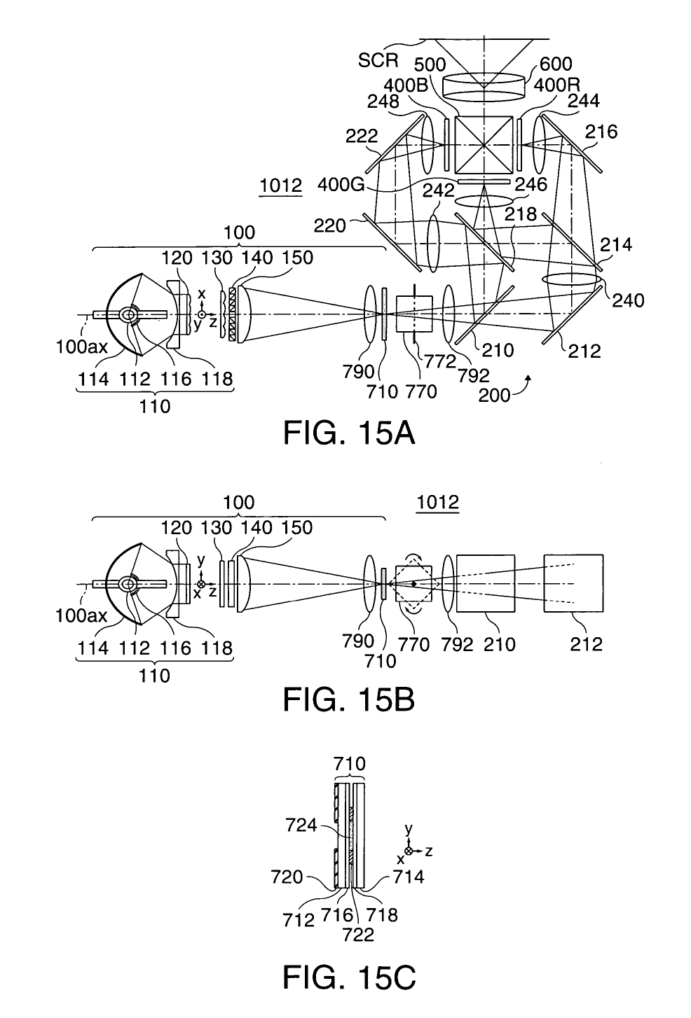

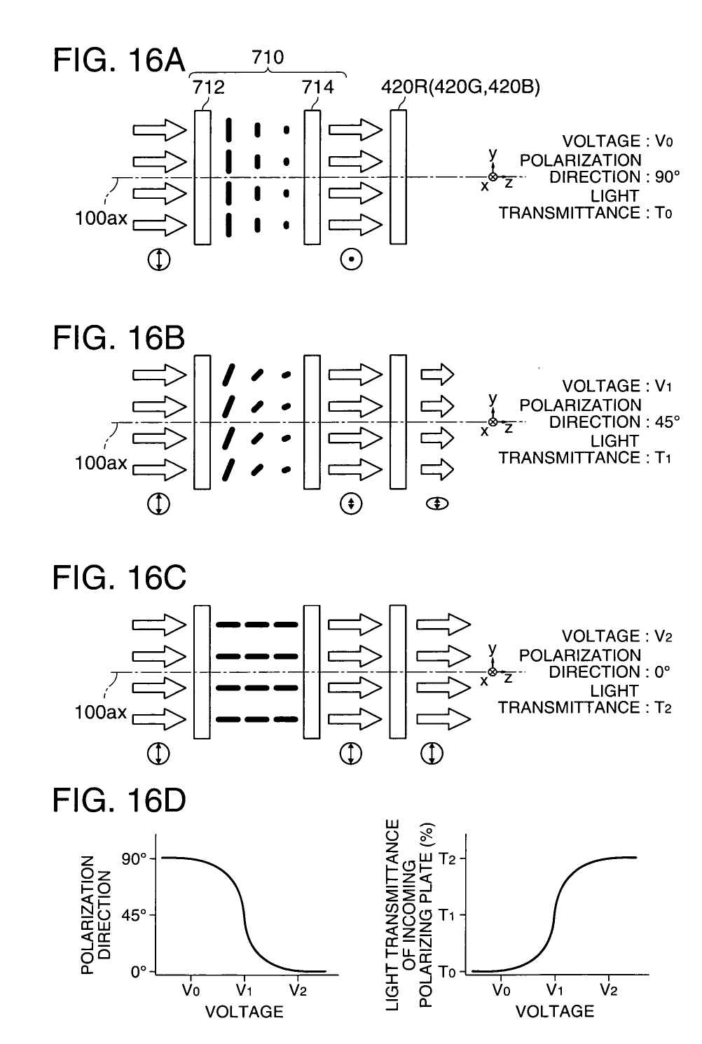

FIGS. 15 and 16 are diagrams illustrative of a projector 1012 according to a seventh exemplary embodiment FIG. 15A is a diagram of an optical system the projector 1012 seen from the top. FIG. 15B is a diagram of the optical system of the projector 1012 seen from the side. FIG. 15C is a cross section of a polarization direction control member 710 seen transversely. FIGS. 16A to 16D are diagrams illustrative of changes in the polarization direction of the illumination light flux emitted from the polarization direction control member 710 when voltage is applied to liquid crystals 724 of the polarization direction control member 710. In addition, in FIGS. 16A to 16C, optical components arranged on the optical path from the polarization direction control member 710 to incoming polarizing plates 420R, 420G and 420B of liquid crystal devices 400R, 400G and 400B are omitted in the drawings. Furthermore, circled arrows depicted in FIGS. 16A to 16C shown polarization components in parallel with the paper surface.

The projector 1012 according to the seventh exemplary embodiment basically has the configuration closely analogous to the projector 1000 according to the first exemplary embodiment. However, as shown in FIGS. 15A to 15C, it is different from the projector 1000 according to the first exemplary embodiment in the configuration of the light transmittance control module.

More specifically, in the projector 1000 according to the first exemplary embodiment, the light transmittance control module has the light transmittance control member 700 and the light transmittance control circuit 740. The light transmittance control member 700 has the polarization direction control member 710 which controls the polarization direction of almost one type of linear polarized light depending on control from the light transmittance control circuit 740, and the polarizing plate 730 which is disposed on the glass substrate 714 on the light emitting side of the polarization direction control member 710 and transmits only the polarization component in the longitudinal direction (the Y-axis direction) in the illumination light flux emitted from the polarization direction control member 710.

On the other hand, in the projector 1012 according to the seventh exemplary embodiment, there is no polarizing plate of exclusive use for the light transmittance control module. As shown in FIG. 15C and FIGS. 16A to 16C, a polarization direction control circuit 744 (not shown) is used as the light transmittance control module, which controls the polarization direction of the polarization direction control member 710 and a polarization direction control member 704. In the light transmittance control module of the seventh exemplary embodiment, instead of the polarizing plate 730 used in the first exemplary embodiment, the incoming polarizing plates 420R, 420G and 420B disposed on the incident side of the liquid crystal devices 400R, 400G and 400B are used.

In addition, as shown in FIG. 15C, the polarization direction control member 710 is the same one as described in the first exemplary embodiment, omitting detailed descriptions.

As described above, the projector 1012 according to the seventh exemplary embodiment is different from the projector 1000 according to the first exemplary embodiment in that the polarizing plate 730 of exclusive use for the light transmittance control module is not disposed on the glass substrate 714 on the light emitting side of the polarization direction control member 710. However, it has almost the same configuration as that of the projector 1000 according to the first exemplary embodiment, except that.

The light transmittance control module of the projector 1012 according to the seventh exemplary embodiment is configured to vary the voltage to be applied to the liquid crystals 724 of the polarization direction control member 710 to change the polarization direction of the illumination light flux passing through the polarization direction control member 710, and to adjust the light quantity of the illumination light flux, absorbed at the incoming polarizing plates 420R, 420G and 420B disposed on the incident side of the liquid crystal devices 400R, 400G and 400B to control the illuminance of the illumination light flux in the liquid crystal devices 400R, 400G and 400B. One of the polarization components of the illumination light flux emitted from the polarization direction control member 710 is transmitted through the incoming polarizing plates 420R, 420G and 420B, whereas the other polarization component is absorbed at the incoming polarizing plates 420R, 420G and 420B.

In addition, FIGS. 16A to 16D shows changes in the polarization direction of the illumination light flux emitted from the polarization direction control member 710 when voltage is applied to the liquid crystals 724 of the polarization direction control member 710. However, the relationship between the voltage to be applied to the polarization direction control member 710 and the changes in the polarization direction of the illumination light flux passing through the polarization direction control member 710 is the same as the case of the first exemplary embodiment, omitting the description.

As described above, the light transmittance control module of the projector 1012 according to the seventh exemplary embodiment is configured to change the voltage applied to the liquid crystals 724 of the polarization direction control member 710 to control the polarization direction without varying the illuminance of the illumination light flux emitted from the polarization direction control member 710, and to adjust the light quantity of the illumination light flux absorbed at the incoming polarizing plates 420R, 420G and 420B disposed on the incident side of the liquid crystal devices 400R, 400G and 400B to control the illuminance of the illumination light flux in the liquid crystal devices 400R, 400G and 400B.

As similar to the light transmittance control circuit 740 of the projector 1000 according to the first exemplary embodiment, the polarization direction control circuit 744 has a function to adjust the voltage to be applied to the polarization direction control member 710 to control the polarization direction of the illumination light flux emitted from the polarization direction control member 710 so as to reduce the difference between the illuminance caused by changes in the rate of travel of the illumination light flux L (the scanning rate) over the image forming areas S of the liquid crystal devices 400R, 400G and 400B.

As described above, the projector 1012 according to the seventh exemplary embodiment is different from the projector 1000 according to the first exemplary embodiment in the configuration of the light transmittance control module which reduces the difference between the illuminance caused by changes in the rate of travel of the illumination light flux (the scanning rate) over the image forming area of the liquid crystal device. However, the polarization direction control member 710 and the polarization direction control circuit 744 are provided as the light transmittance control module. Therefore, the difference between the illuminance caused when the rotating prism 770 is rotated at a constant rotation speed is reduced, and more uniform display can be done throughout the screen SCR. More specifically, uniform in-plane display properties are provided.

Furthermore, according to the projector 1012 of the seventh exemplary embodiment, as described above, the light transmittance control module is configured by using the incoming polarizing plates 420R, 420G and 420B of the liquid crystal devices 400R, 400G and 400B without using the polarizing plate of exclusive use for the light transmittance control module. Thus, the number of components can be reduced, and the fabrication efficiency of the projector can be improved.

In the projector 1012 according to the seventh exemplary embodiment, the polarization direction control member 710 is disposed at the position almost optically conjugated with each of the first small lenses 122 and the image forming areas of the liquid crystal devices 400R, 400G and 400B.

In the projector according to some exemplary embodiments of the invention, the polarization direction control member may be disposed at any places as long as it is disposed in the optical path through which the illumination light flux passes. However, the cross-sectional area of the illumination light flux is small at the position almost optically conjugated with each of the first small lenses 122 and the image forming areas of the liquid crystal devices 400R, 400G and 400B. Therefore, as described above, the polarization direction control member 710 is disposed at this place to reduce the size of the polarization direction control member 710, allowing a reduction in fabrication costs.

IN addition, it is also preferable that the polarization direction control member 710 is disposed near the liquid crystal devices 400R, 400G and 400B (the position between the field lenses 244,246 and 248 and the incoming polarizing plates 420R, 420G and 420B).

Moreover, in the projector 1000 according to the first exemplary embodiment, the polarization direction control member 710 further has the function as the light shielding member which shapes the sectional form of the illumination light flux. Therefore, the sectional form of the illumination light flux emitted from the polarization direction control member 710 can be correctly shaped into the sectional form of the image forming areas S of the liquid crystal devices 400R, 400G and 400B.

In addition, since the projector 1012 according to the seventh exemplary embodiment has the same configuration as that of the projector 1000 according to the first exemplary embodiment at this point, it has the same effect as that of the projector 1000 according to the case of the first exemplary embodiment.

As describe above, the projector according to an exemplary embodiment of the invention has been described based on each of the embodiments but the invention is not limited to each of the embodiments. The invention can be implemented in various forms within the scope. For example, the following modifications are possible.

According to modification 1, although the projectors 1000 to 1010 of the embodiments 1 to 6 use the light transmittance control member of liquid crystal as the light transmittance control members 700, 702R, 702G and 702B, the invention is not limited thereto, the light transmittance control member of electrochromic materials and electrophoretic materials can preferably be used.

According to modification 2, although the projectors 1000 to 1006 and 1012 of the embodiments 1 to 4 and 7 use “a rectangle of length to width □ 1:4” for a plane form of the first small lenses 122 of the first lens array 120, the invention is not limited thereto, any forms are fine as long as the form can intermittently illuminate over the image forming area so as to improve the moving picture display quality of the liquid crystal device. For example, forms such as “a rectangle of length to width □ 9.:32” and “a rectangle of length width □ 3:8” can also preferably be used.

According to modification 3, although the projectors 1008 and 1010 of the embodiments 5 and 6 uses “a rectangle of length to width □ 1:4” as a plane form of the light emitting plane of the integrator rod 160, the invention is not limited thereto, any forms are fine as long as the form can intermittently illuminate over the image forming area so as to improve the moving picture display quality of the liquid crystal device. For example, forms such as “a rectangle of length to width □ 9:32” and “a rectangle of length to width □ 3:8” can also preferably be used.

According to modification 4, although the projector 1004 of the third exemplary embodiment uses the light shielding member with the opening 782 having “a rectangular plane form, the length in the Y-axis direction to the width in the X-axis direction □ 1:4” for the light shielding member 780, the invention is not limited thereto, any forms are fine as long as the form can intermittently illuminate over the image forming area so as to improve the moving picture display quality of the liquid crystal device. For example, a light shielding member may be used which has an opening having “a rectangular plane form, the length in the Y-axis direction to the width in the X-axis direction □9:32.”Furthermore, when the first small lens of the first lens array is a small lens having a plane from other than “a rectangular plane form, the length in the Y-axis direction to the width in the X-axis direction □ 1:4”, a light shielding member may be used which has an opening having a plane form analogous to a plane form of that small lens. When the light emitting plane of the integrator rod is that of an integrator rod having a place form other than “a rectangular plane form, the length in the Y-axis direction to the width in the X-axis direction □ 1:4”, a light shielding member may be used which has an opening having a plane form analogous to a plane form of the light emitting plane of that integrator rod.

According to modification 5, although the projectors 1000 to 1006 and 1012 of the embodiments 1 to 4 and 7 use as the light source device 110 the light source device having the ellipsoidal reflector 114, the arc tube 112 having the center of light emission near the first focal point of the ellipsoidal reflector 114, and the parallel lens 118, the invention is not limited thereto, a light source device having a parabolic reflector, an arc tube having the center of light emission near the focal point of the parabolic reflector can also preferably be used.

According to modification 6, although the projectors 1000 to 1012 of the each of embodiments use as the light source devices 110 and 110B the light source device in which the auxiliary mirror 116 is disposed on the arc tube 112, the invention is not limited the thereto, and a light source device with no auxiliary mirror disposed on an arc tube can also preferably be used. According to modification 7, although the projector using three liquid crystal devices 400R, 400G and 400B is exemplified and described in the each of embodiments, the invention is not limited thereto, this can also be adapted to a projector using one, two or four or more or more of liquid crystal devices.

According to modification 8, although the projectors 1000 to 1012 of each of the embodiments use the liquid crystal device as the electrooptic modulator, the invention is not limited thereto. For the electrooptic modulator, generally, modulators are fine that modulate incident light in accordance with image information, and micromirror type light modulators may be used. For micromirror type light modulators, for example DVD (Digital Micromirror Device)(a trademark of Texas Instruments Incorporated) can be used.

According to modification 9, although the invention can be adapted to a front projection projector that projects a projected image from the observation side as well as to a rear projection projector that projects a projected image from the opposite side of the observation side of the projected image.

Further, while this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

The priority applications Numbers JP2005-052597 and JP2005-321819 upon which this patent application is based is hereby incorporated by reference.

What is claimed is:

1. A projector comprising:
an electrooptic modulator that modulates an illumination light flux in accordance with image information;
a projection optical system that projects the illumination light flux modulated by the electrooptic modulator;
an illuminating system that so as to illuminate an entire image forming area in one direction on an image forming area of the electrooptic modulator and to partially illuminate the image forming area in the other direction, emits an illumination light flux having a sectional form compressed in the other direction of directions;
a rotating prism that is rotated at a constant speed to perform scanning with an illumination light flux from the illuminating system along the other direction over the image forming area of the electrooptic modulator; and
a light transmittance control module that changes a light transmittance of the illumination light flux depending on a position of the illumination light flux over the image forming area so as to reduce a difference in illuminance caused by changes in a scanning rate of the illumination light flux over the image forming area of the electrooptic modulator.

2. The projector according to claim 1, wherein the light transmittance control module having a light transmittance control member and a light transmittance control circuit the controls light transmittances of the light transmittance control member.

3. The projector according to claim 2, further comprising:
a polarization conversion device that rearranges the illumination light flux into almost one type of linear polarized light
wherein the electrooptic modulator being a liquid crystal device, the light transmittance control member having a polarization direction control member that controls a polarization direction of the almost one type of linear polarized light depending on control from the light transmittance control circuit; and a polarizing plate that transmits only one polarization component of polarization components of an illumination light flux emitted from the polarization direction control member.

4. The projector according to claim 3, wherein the polarizing plate being disposed on a light emitting side of the polarization direction control member.

5. The projector according to claim 3, wherein for the polarizing plate, an incoming polarizing plate being used which is disposed on an incident side of the electrooptic modulator to rearrange a polarization direction of an illumination light flux to enter the electrooptic modulator.

6. The projector according to claim 2, further comprising
a rotating state sensor that senses a rotating state of the rotating prism,
wherein the light transmittance control circuit controlling a light transmittance of the light transmittance control member based on the output signal of the rotating state sensor.

7. The projector according to claim 2, further comprising
an image processing circuit that processes image information,
wherein the rotating prism being configured to rotate at a constant speed based on a synchronization signal from the image processing circuit, and
the light transmittance control circuit controlling a light transmittance of the light transmittance control member based on a synchronization signal from the image processing circuit.

8. The projector according to claim 3, further comprising
a rotating state sensor that senses a rotating state of the rotating prism,
wherein the light transmittance control circuit controlling a light transmittance of the light transmittance control member based on the output signal of the rotating state sensor.

9. The projector according to claim 3, further comprising
an image processing circuit that processes image information,
wherein the rotating prism being configured to rotate at a constant speed based on a synchronization signal from the image processing circuit, and
the light transmittance control circuit controlling a light transmittance of the light transmittance control member based on a synchronization signal from the image processing circuit.

10. The projector according to claim 4, further comprising
a rotating state sensor that senses a rotating state of the rotating prism,
wherein the light transmittance control circuit controlling a light transmittance of the light transmittance control member based on the output signal of the rotating state sensor.

11. The projector according to claim 4, further comprising
an image processing circuit that processes image information,
wherein the rotating prism being configured to rotate at a constant speed based on a synchronization signal from the image processing circuit, and
the light transmittance control circuit controlling a light transmittance of the light transmittance control member based on a synchronization signal from the image processing circuit.

12. The projector according to claim 5, further comprising
a rotating state sensor that senses a rotating state of the rotating prism,
wherein the light transmittance control circuit controlling a light transmittance of the light transmittance control member based on the output signal of the rotating state sensor.

13. The projector according to claim 5, further comprising
an image processing circuit that processes image information,
wherein the rotating prism being configured to rotate at a constant speed based on a synchronization signal from the image processing circuit, and
the light transmittance control circuit controlling a light transmittance of the light transmittance control member based on a synchronization signal from the image processing circuit.

14. The projector according to claim 2,
wherein the illuminating system being an illuminating system having:
a light source device that includes an arc tube and a reflector and that emits an illumination light flux to an illuminated area side;
a first lens array that has a plurality of first small lenses to split an illumination light flux emitted from the light source device into a plurality of partial light fluxes;
a second lens array that has a plurality of second small lenses corresponding to a plurality of the first small lenses of the first lens array; and
an superposing lens that superposes with the light transmittance control member each of the partial light fluxes emitted from a plurality of the second small lenses of the second lens array,
wherein the first small lenses having a plane form compressed in the other direction, respectively

15. The projector according to claim 1,
wherein the illuminating system is an illuminating system having:
a light source device that includes an arc tube and an ellipsoidal reflector and that emits a converging illumination light flux to an illuminated area side; and
an integrator rod that converts an illumination light flux from the light source device into an illumination light flux having more uniform intensity distribution,
wherein a light emitting plane of the integrator rod having a plane form compressed in the other direction.

16. The projector according to claim 1, wherein the rotating prism being disposed at a position almost optically conjugated with the image forming area of the electrooptic modulator.

17. The projector according to claim 2, wherein the polarization direction control member being disposed at a position almost optically conjugated with the image forming area of the electrooptic modulator.

18. The projector according to claim 17, wherein the polarization direction control member further having a function as a light shielding member that shapes a sectional form of an illumination light flux.
